(19) United States
(12) Patent Application Publication
(10) Pub. No.: US 2023/0169434 A1
(43) Pub. Date: Jun. 1, 2023

(54) BEHAVIORAL ECONOMICS BASED FRAMEWORK FOR OPTIMAL AND STRATEGIC DECISION-MAKING IN A CIRCULAR ECONOMY

(71) Applicant: Hitachi, Ltd., Tokyo (JP)

(72) Inventors: Amit KUMAR, San Jose, CA (US); Nam HUYN, Milpitas, CA (US); Shouchun PENG, San Jose, CA (US); Ravigopal VENNELAKANTI, San Jose, CA (US)

(21) Appl. No.: 17/539,130

(22) Filed: Nov. 30, 2021

(51) Int. Cl. G06Q 10/06; G06Q 30/02

(52) U.S. Cl. CPC G06Q 10/06375; G06Q 10/06315; G06Q 10/067; G06Q 30/0204

(57) ABSTRACT

A method of providing optimal and personalized business decision making that leverages behavioral economics principles and machine learning techniques is discussed herein. The method may include collecting or simulating data relating to behavioral characteristics of a plurality of stakeholders and analyzing the collected data to construct behavioral economics and machine learning based models related to a business problem. These models can be used to optimize and personalize business interventions to influence consumers' purchasing behavior to achieve the best business outcome (in B2C use cases) and de-bias distorted information sharing in supply chains (in B2B use cases). By contrast, traditional consumer and supply chain analytics solutions lack behavioral insights and often lead to sub-optimal decision making because economic optimization approach alone is not adequate for decision making where behavioral biases are present.

### BACKGROUND

### Field

The present disclosure is generally directed to providing an end-to-end framework for behavioral segmentation of target stakeholder groups, designing business action types suitable for each stakeholder group, and recommending optimal and personalized business action types for each potential stakeholder in a group.

### Related Art

The success of a product may largely be based on its customers' perceived value. The perceived value may be heavily influenced by customers' beliefs and behavioral biases during the product's lifecycle. Understanding and shaping customer behavior for promoting circular economy products (repurposed/remanufactured/recycled) may be even more challenging because research on customer valuation of circular economy products is still in its infancy.

In a business to consumer (B2C) scenario, only a subset of customers who report positive attitudes toward eco-friendly products finally purchase those products. On the other hand, information asymmetry in a business to business (B2B) scenario (one party has more or superior information than others) can result in value chain inefficiencies such as wasted inventory, price manipulation, and poor customer satisfaction. An information gap may be much wider in multi-tier value chain ecosystems since there are multiple links, exchanges, and individual profit-maximizing goals.

Traditional consumer and supply chain analytics solutions seldom account for consumers' and stakeholders' biases and hence yield only suboptimal results. While the field of behavioral economics (BE) has much to offer in terms of identifying human biases in general decision making, bias models tailored to business problems may be hard to come by. Even when business interventions recommended by a BE model can be effective at the level of a population, it may not provide desired results at the individual stakeholder level. Accordingly, the system, method, and apparatus below may provide recommendations for business actions at the individual stakeholder level.

### SUMMARY

Example implementations described herein include an innovative method of providing optimized business decision-making that leverages behavioral economics principles, agent-based modeling and simulation, and machine learning techniques. The method may include collecting data relating to behavioral characteristics of a plurality of stakeholders, the collected data comprising at least data required to analyze stakeholder behaviors using a behavioral economics model. The method may further include modeling and simulation of stakeholder interactions based on the collected behavioral data to provide optimal business action type recommendations for target stakeholder groups. The method may further include experimentation with the recommended business action types to gather empirical evidence of business action's outcomes and use the collected evidence data to train a machine-learning based personalized business action recommendation engine that provides optimal personalized business action based on the state of individual stakeholder interaction.

Example implementations described herein include an innovative computer-readable medium storing computer executable code for providing personalized business action recommendations by a personalized business action recommendation engine. The code when executed by the processor may cause the processor to collect data relating to behavioral characteristics of a plurality of stakeholders, the collected data comprising at least data required to analyze stakeholder behaviors using a behavioral economics model. The code when executed by the processor may further cause the processor to generate, based on the collected data, simulated stakeholder interactions data for target stakeholder groups. The code when executed by the processor may cause the processor to collect empirical evidence data of business action's outcomes. The code when executed by the processor may also cause the processor to train, based on the collected empirical evidence data, a machine-learning based personalized business action recommendation engine that provides optimal personalized business action based on the state of individual stakeholder interaction.

Example implementations described herein include an innovative system for providing personalized business action recommendations by a personalized business action recommendation engine. The system may include means for collecting data relating to behavioral characteristics of a plurality of stakeholders, the collected data comprising at least data required to analyze stakeholder behaviors using a behavioral economics model. The system may also include means for generating, based on the collected data, simulated stakeholder interactions data for target stakeholder groups. The system may further include means for collecting empirical evidence data of interventions' outcomes data. The system may further include means for training, based on the collected empirical evidence data, a machine-learning based personalized business action recommendation engine that provides optimal and personalized business action based on the state of individual stakeholder interaction.

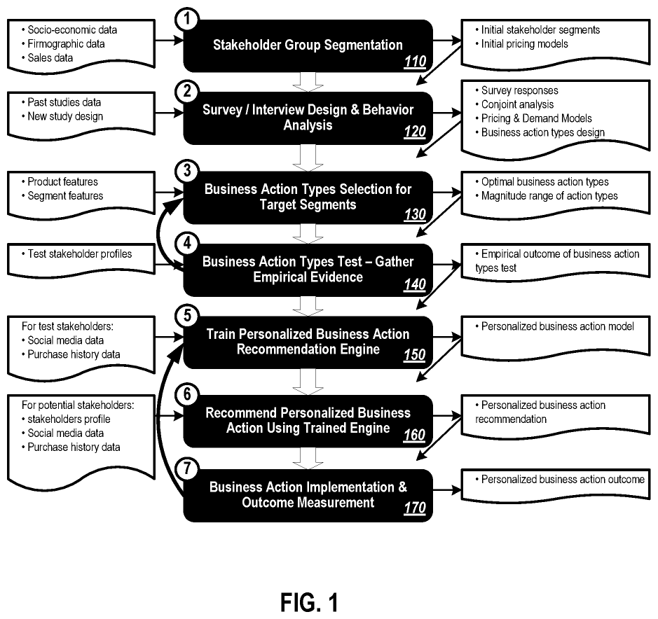

FIG. 1 illustrates an end-to-end framework (7-step method) for collecting behavioral data, training, and using personalized business action recommendation engine.

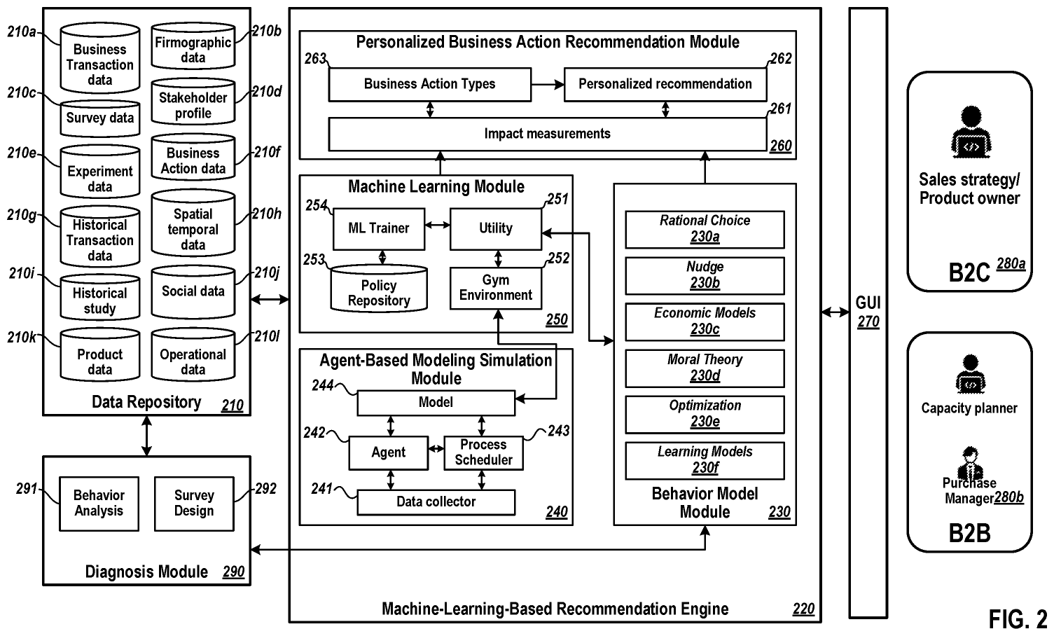

FIG. 2 is a diagram of an example computing environment of the BE-based framework for optimal and personalized business decision making.

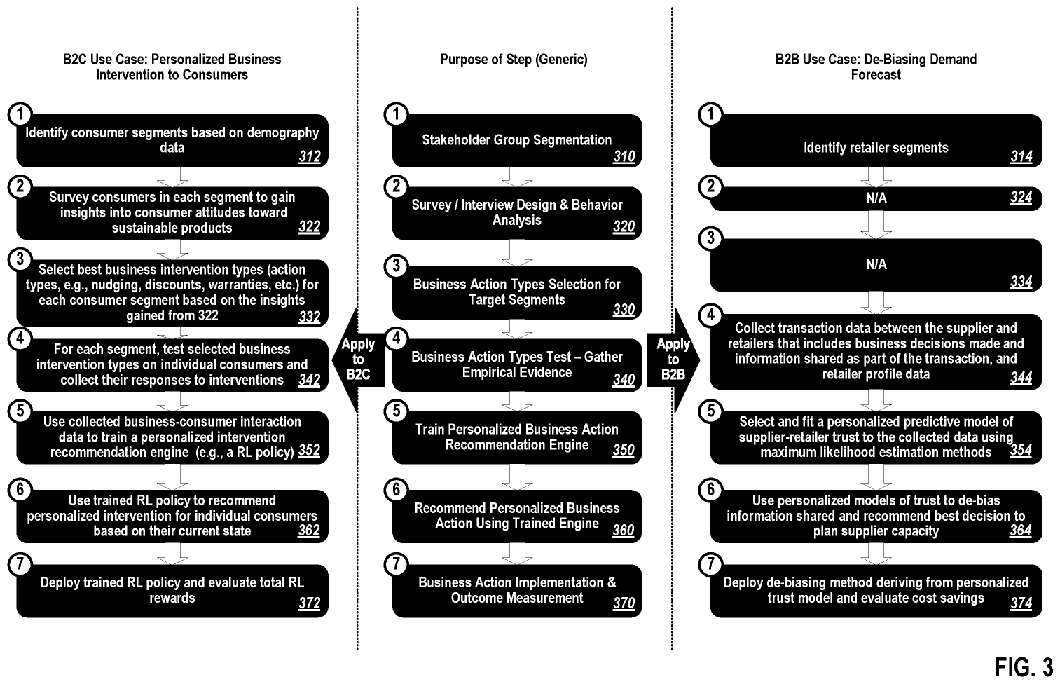

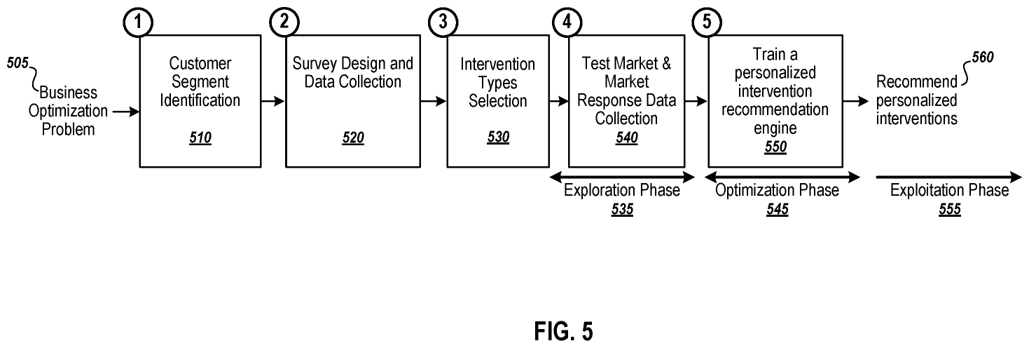

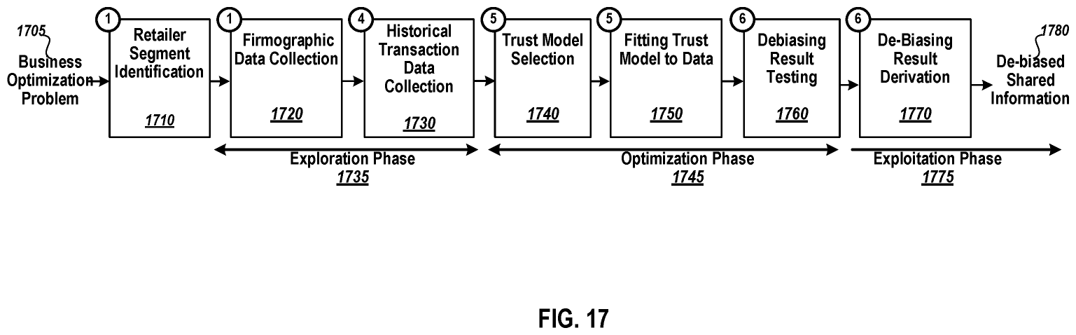

FIG. 3 illustrates mappings of the generic 7-step method described in relation to FIG. 1 to individual use cases as will be described in more detail in relation to FIGS. 5 and 17.

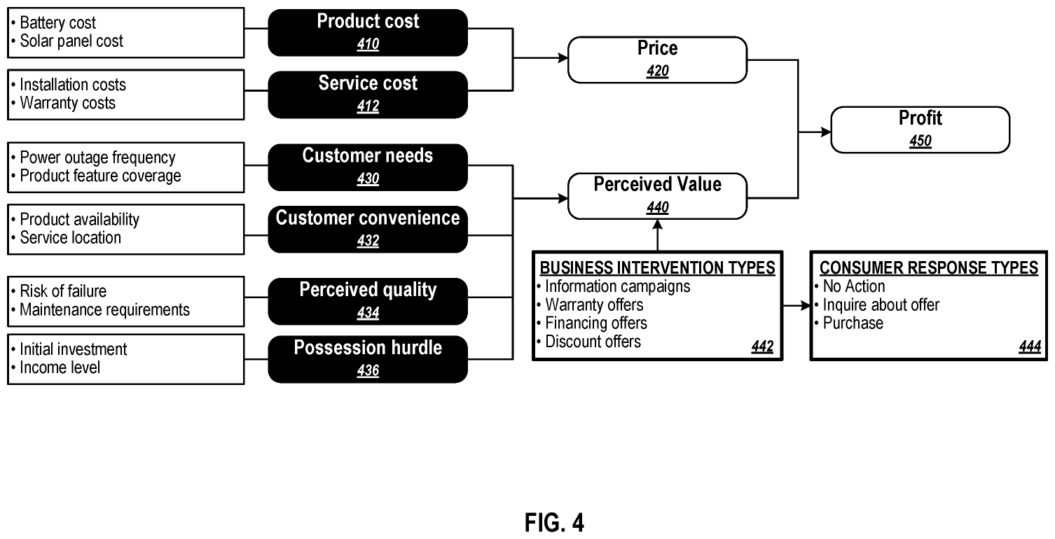

FIG. 4 illustrates a set of inputs to a consumer decision that may be considered in generating a set of interventions and/or models for a use case related to solar power and storage.

FIG. 5 illustrates an implementation of the stages illustrated in FIG. 1 for the first use case (B2C use case),

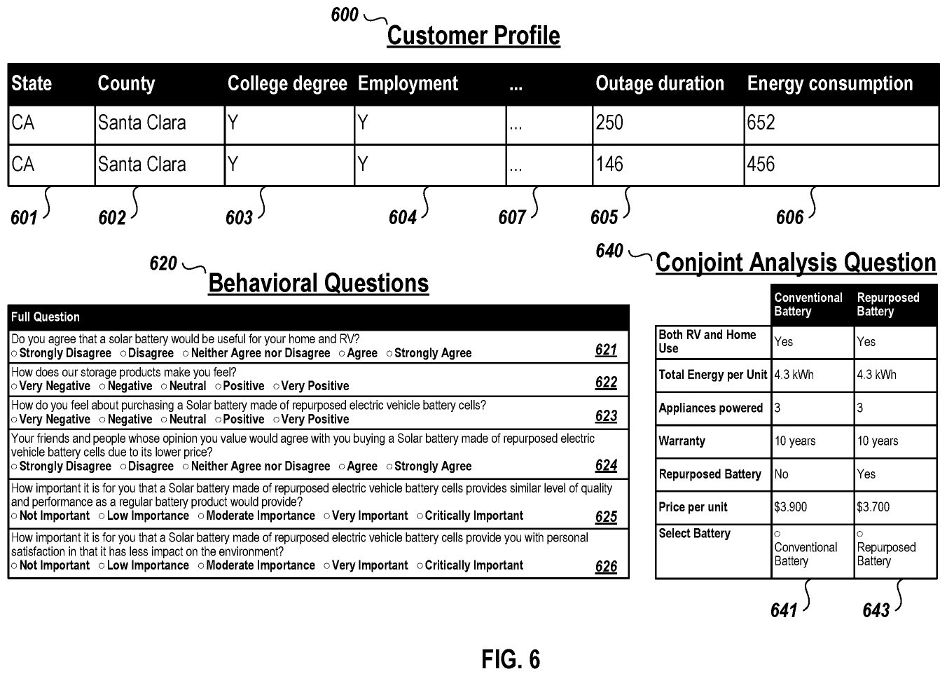

FIG. 6 illustrates an example consumer demographics profile data collected for the B2C use case related to incentivizing consumers to buy energy storage products built out of repurposed batteries.

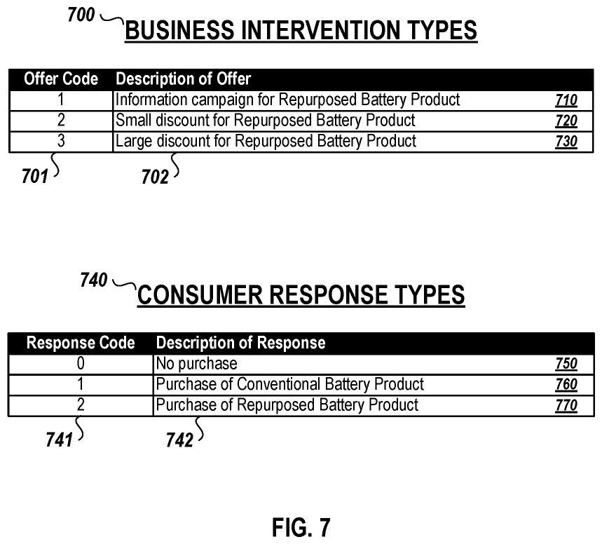

FIG. 7 illustrates a set of business intervention types for an example business optimization problem relating to the introduction of a repurposed battery storage product and a set of possible customer responses types for the example use case.

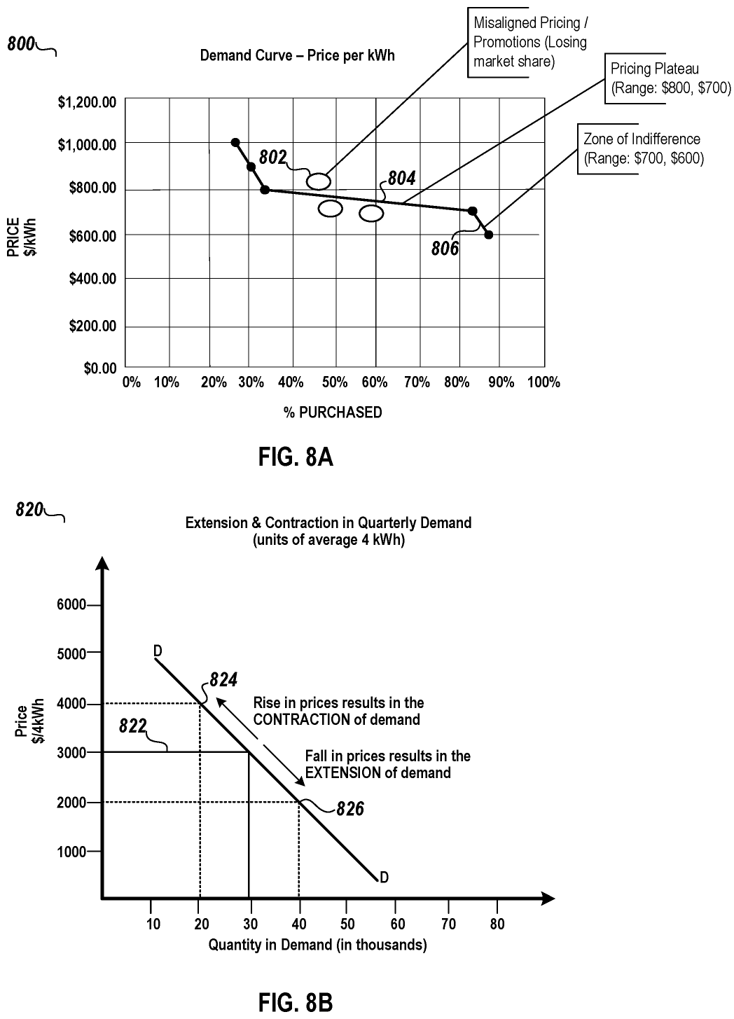

FIG. 8A illustrates an example demand curve chart identifying a demand at different prices per kWh for the repurposed battery example discussed in relation to FIGS. 4-7.

FIG. 8B illustrates an example demand curve for electricity.

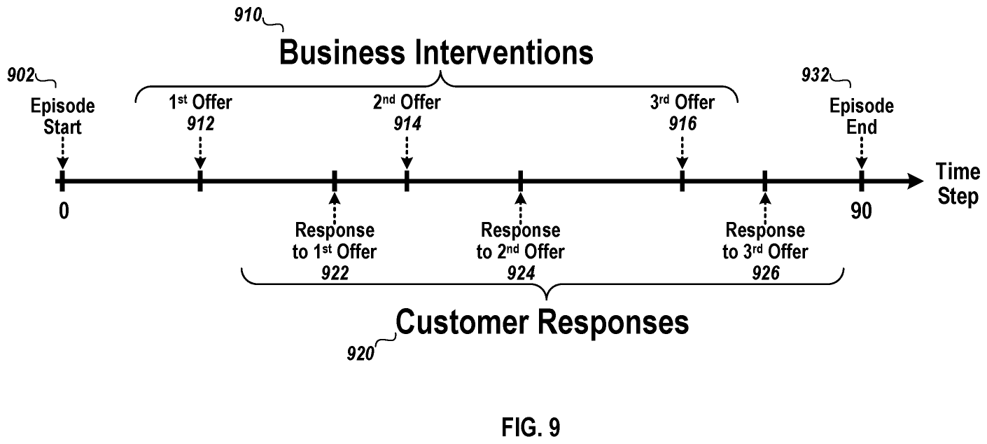

FIG. 9 illustrates an example business-customer interaction episode where business interventions and customer responses are interleaved.

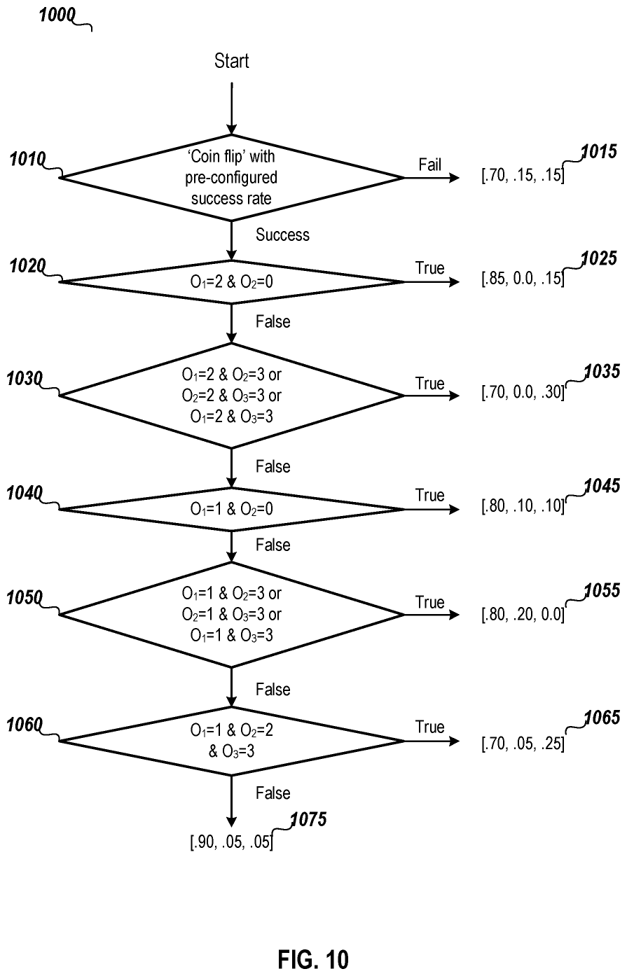

FIG. 10 is a flow diagram illustrating an example of customer's purchasing behavior in response to business interventions, where the purchasing behavior is sufficiently formalized that it can be executed in an agent-based simulation engine to simulate customers' responses.

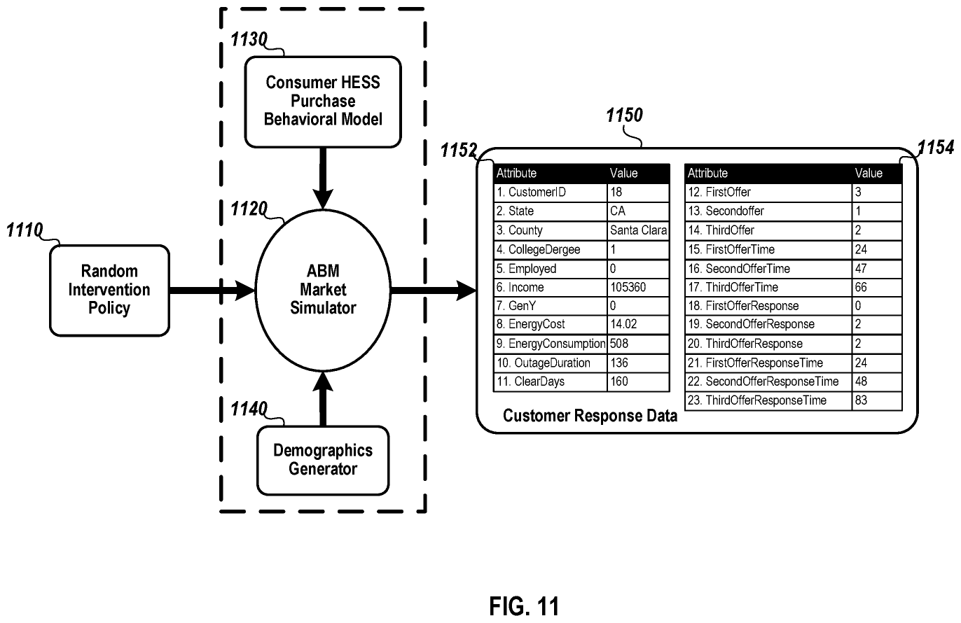

FIG. 11 conceptually illustrates how customer response data can be synthesized by injecting a random intervention policy to an agent-based modeling market simulator. The synthetic customer response data generated by the simulator will be used later to train an optimized intervention policy.

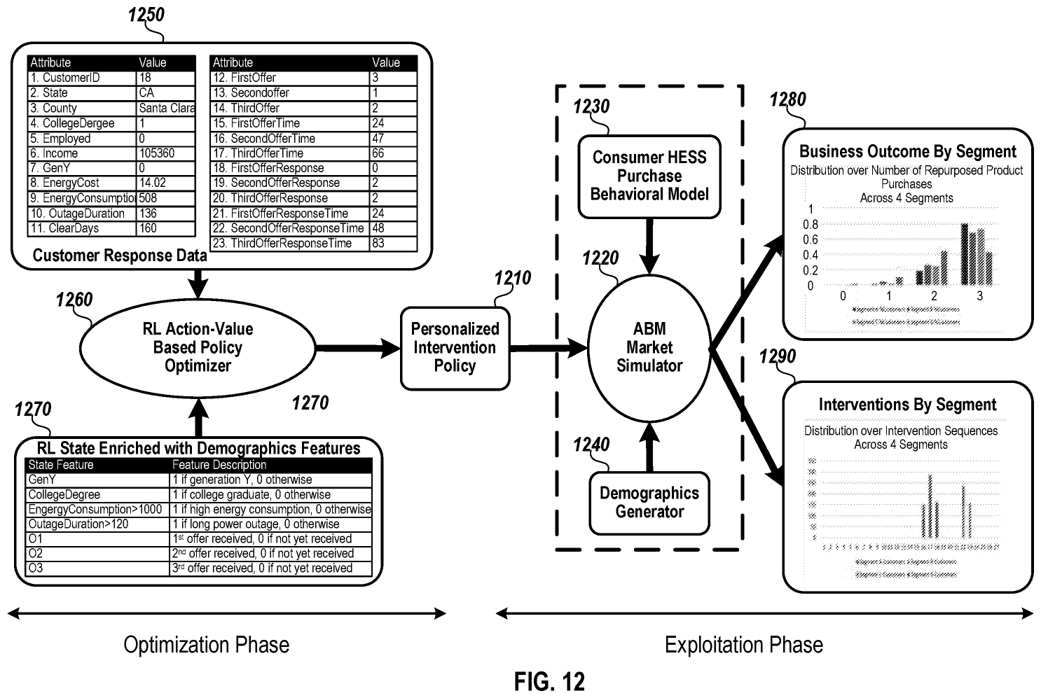

FIG. 12 illustrates how reinforcement learning can be used to optimize/personalize a business intervention policy, which can then be deployed, tested and evaluated in the same ABM market simulator used for data generation.

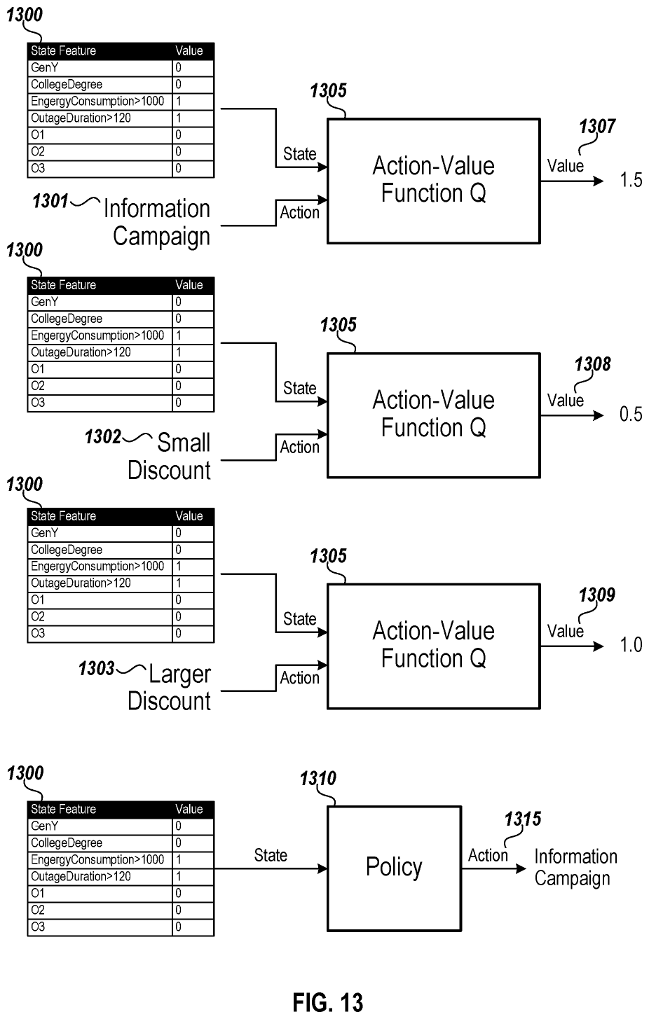

FIG. 13 is an example of a particular reinforcement learning technique that tries to estimate an action-value function (Q) that indicates a value associated with a state and a particular intervention.

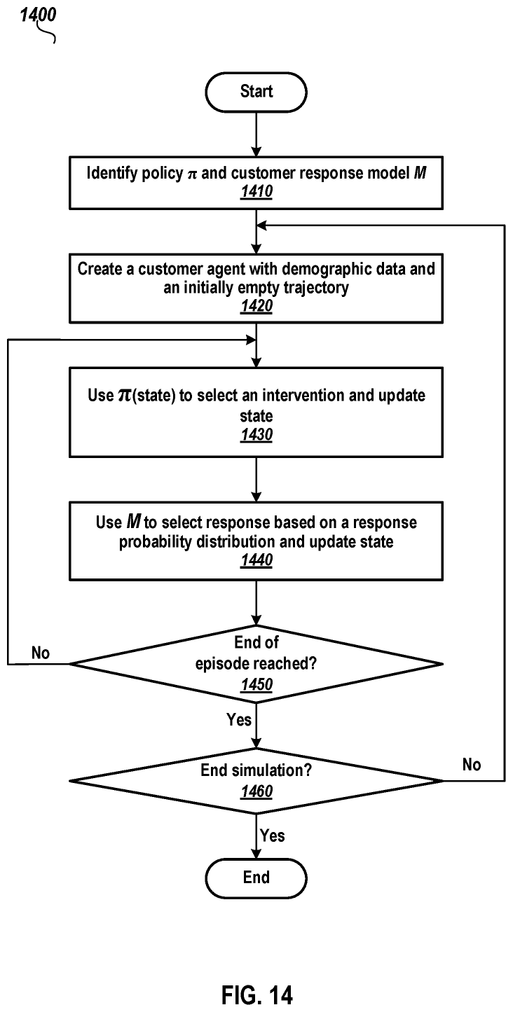

FIG. 14 illustrates a flow diagram of running a simulation experiment where an injected business intervention policy is applied to simulated customers with given purchasing behaviors.

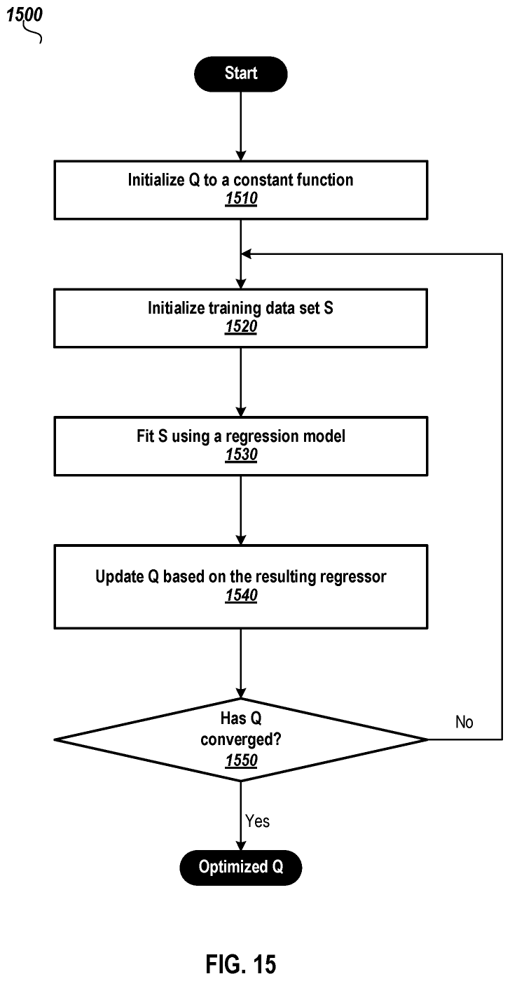

FIG. 15 is a flow diagram of a method for iteratively improving the estimation of an action-value function as described in relation to FIG. 12,

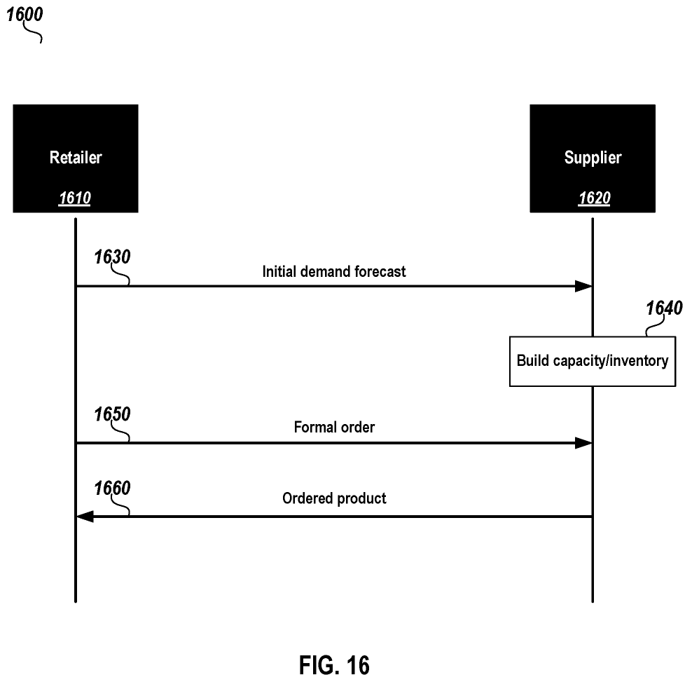

FIG. 16 is a call flow diagram of a second example use case of a 2-participant supply chain related to debiasing demand forecasts.

FIG. 17 illustrates an implementation of the stages illustrated in FIG. 3 for a second, B2B use case relating to debiasing demand forecasts.

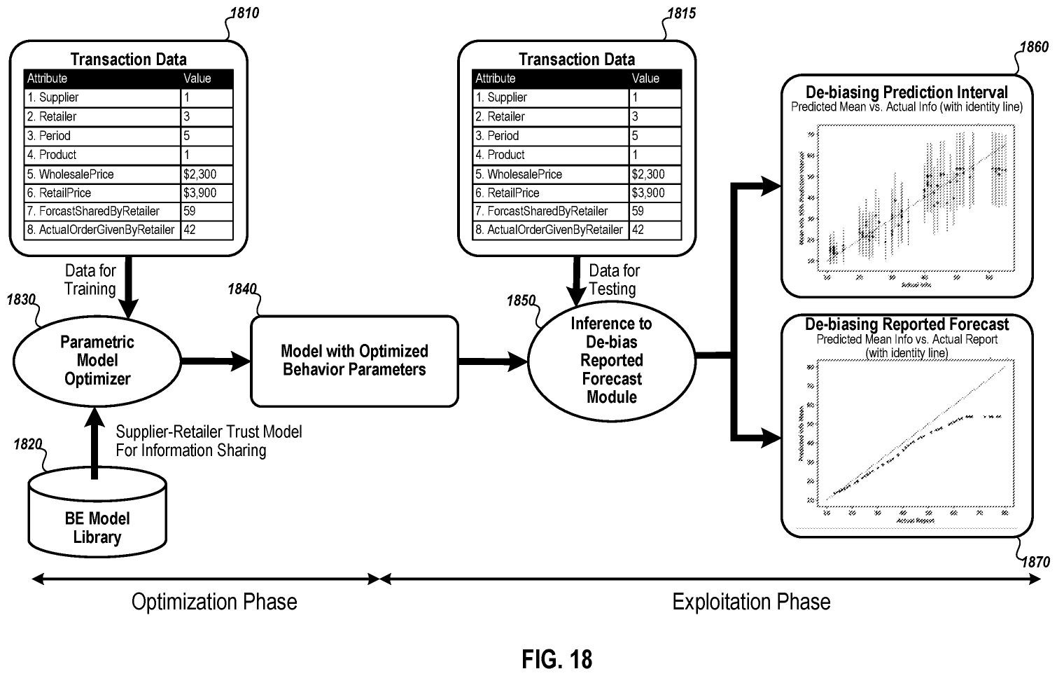

FIG. 18 illustrates an architecture for a forecast debiasing system based on a behavioral economics model of trust in supplier-retailer information sharing.

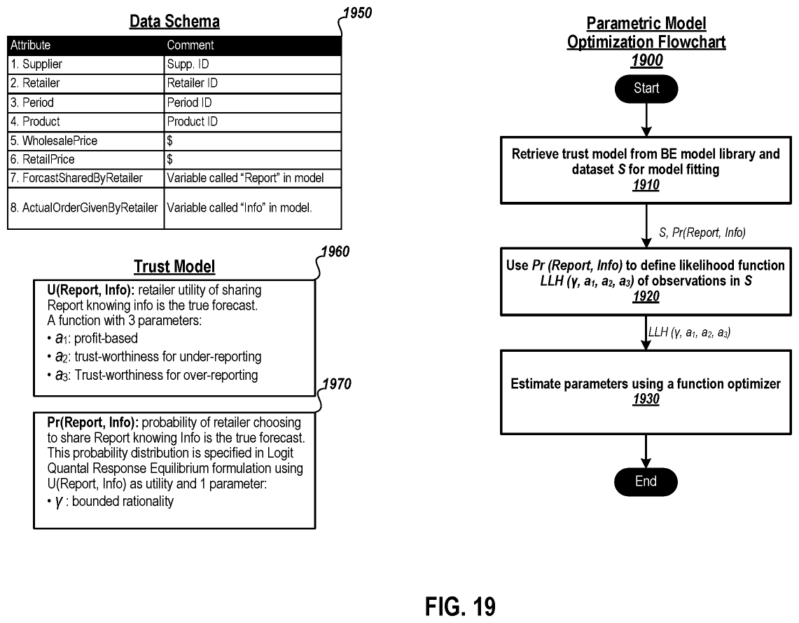

FIG. 19 is a flow diagram for a parametric BE model optimization, an associated data schema for data used to fit the model, and the model parameters.

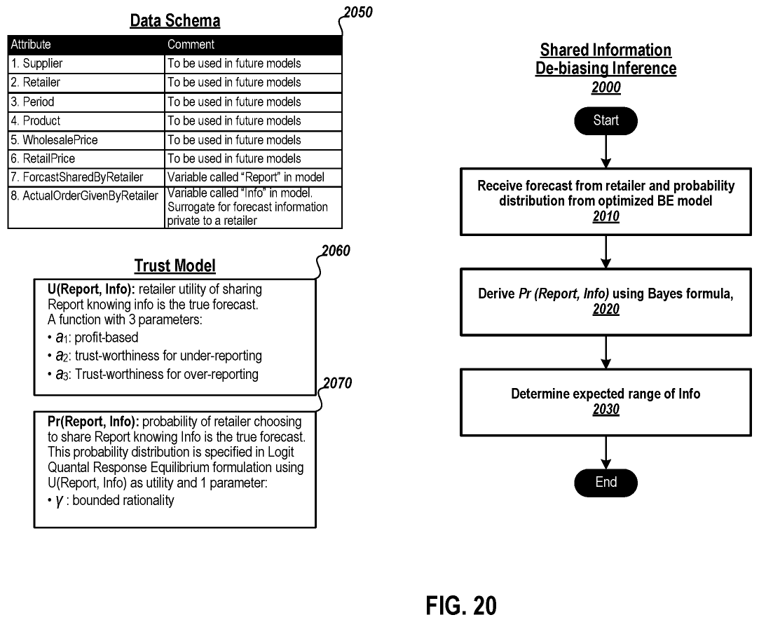

FIG. 20 is a flow diagram for a shared information de-biasing inference, an associated data schema, and model parameters.

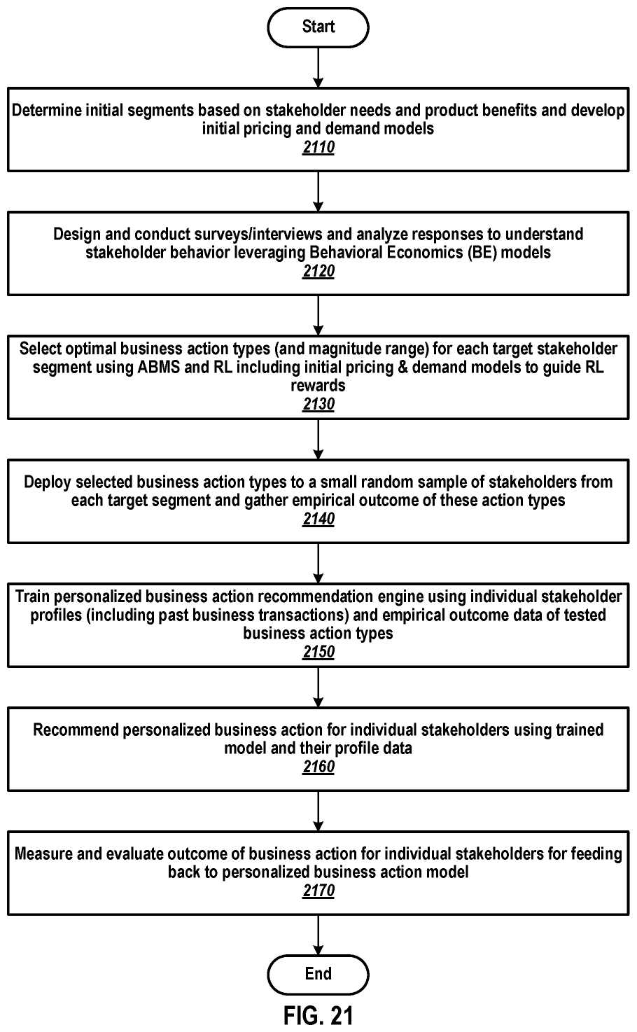

FIG. 21 is a flow diagram of a method for providing personalized behavioral intervention recommendations when customer interaction data needed for training is not available in real life but could be synthesized through simulation.

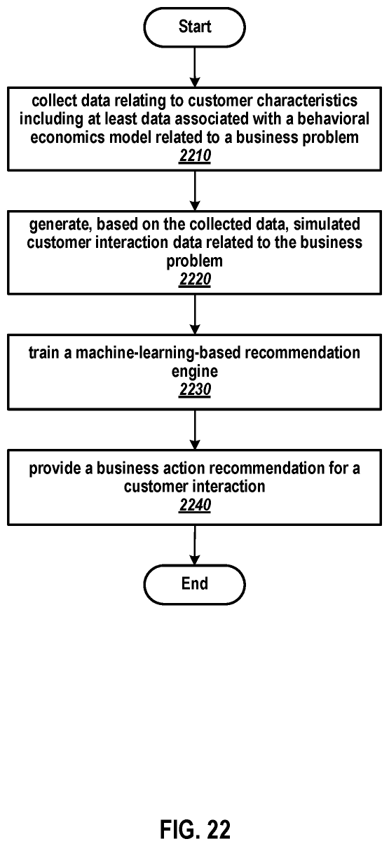

FIG. 22 is a flow diagram of a method for providing business action recommendations

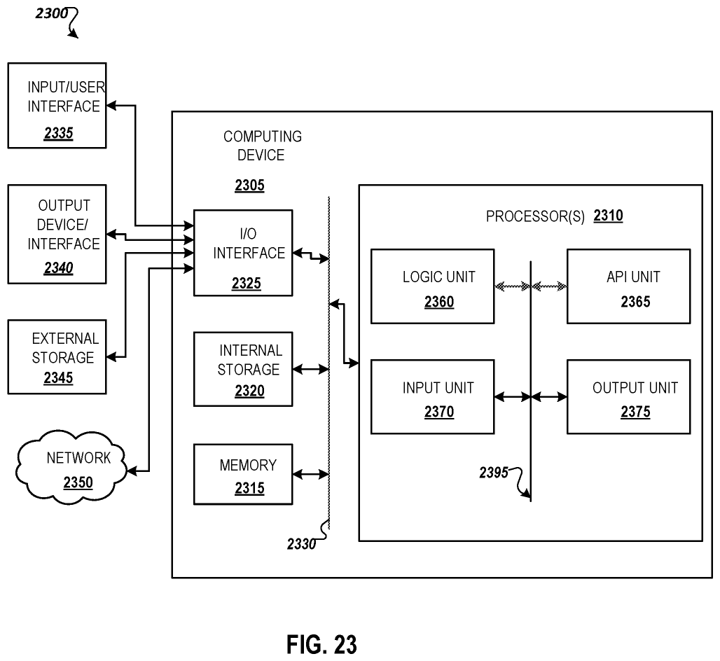

FIG. 23 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations described herein relate to an innovative machine-learning-based recommendation engine (e.g., personalized business intervention engine), a method performed by the machine-learning-based recommendation engine, a computer-readable medium computer executable code for implementing the machine-learning-based recommendation engine, and a system including the machine-learning-based recommendation engine. The system may include collecting data relating to behavioral characteristics of a plurality of stakeholders, where stakeholders refer to customers in B2C use cases or supply chain participants in B2B use cases. The system may further generate, based on the collected data, simulated or collected in the real-world stakeholder interaction data related to the business problem. The system may also train, based on the stakeholder interaction data, a machine-learning-based recommendation engine. The system may further provide a business action recommendation for a stakeholder interaction, where the business action recommendation is provided by the trained machine-learning-based recommendation engine based on a state of the stakeholder interaction.

FIG. 1 illustrates an end-to-end framework (7-step method) for collecting behavioral data, training, and providing personalized business action recommendations. The latter may be performed by a machine-learning-based recommendation engine or a system that includes a machine-learning-based recommendation engine, e.g., a system illustrated in FIGS. 2 and 12. At a first “Stakeholder Group Segmentation” stage 110, stakeholder's needs, product benefits, socio-economic data, firmographic data, sales data, and so on may be used to generate initial target segments and initial pricing and demand models. The initial target segmentation and initial pricing models may be used to inform the “Survey/Interview Design & Behavior Analysis” stage 120. Stage 120 may also be informed by data from past studies and includes an analysis of the survey responses to understand stakeholder behavior leveraging BE models. The survey may be designed to elicit information regarding behavioral factors (e.g., beliefs, values, environmental factors, and so on) and/or may be designed to compare preferences between two or more choices based on a comparison of features and prices (e.g., a conjoint analysis). The behavioral questions in the survey may relate to at least one of attitudes towards a product, perceived attitudes of other people towards the product, or an importance of different features of the product. The survey questions and conjoint analysis questions may be generated based on behavioral economics principles as discussed below in relation to FIGS. 5 and 6. The survey and/or behavior analysis may also be used to identify or generate pricing and demand models (e.g., related to a demand curve and/or price elasticity) and/or possible business actions. Some elements related to Stage 120 are discussed below in relation to FIGS. 6-8 pertaining to B2C use case as an example.

The “Business Action Types Selection for Target Segments” stage 130 may be informed by the “Survey/Interview Design & Behavior Analysis” stage 120, product features, features of different stakeholder segments (e.g., identified during the “Stakeholder Group Segmentation” stage 110), and feedback from subsequent stages (e.g., the “Business Action Types Test—Gather Empirical Evidence” stage 140). Stage 130 may produce a set of best business action types and magnitude ranges of the business action types (e.g., amounts of discount). The selection of best business action types may use ABMS and RL including initial pricing and demand models to guide RL rewards. The best business action types may be a set of business action types that maximize a profit or other metric based on a current state of an interaction episode and a set of characteristics of a customer. The best business action types may be produced based on a RL module (or other machine learning component) and/or methodology.

Based on the current best business action types and magnitude ranges produced by the “Business Action Types Selection for Target Segments” stage 130 as well as a set of test customer profiles, a “Business Action Types Test—Gather Empirical Evidence” stage 140 may deploy selected business action types to a small random sample of stakeholders from each target segment and gather empirical outcome of these action types. In some aspects, the test stakeholder profiles may include stakeholder interaction data. The empirical outcomes of the testing may be fed back to Stage 130, e.g., to be used to train a reinforcement learning module and/or update a training of the reinforcement learning module (or other machine learning module, neural network, or other similar module).

From the business action types identified at the “Business Action Types Selection for Target Segments” stage 130 and the empirical data generated by the “Business Action Types Test—Gather Empirical Evidence” stage 140, the system may, at the “Train Personalized Business Action Recommendation Engine” stage 150, train a personalized business action recommendation engine using individual stakeholder profiles (including past business transactions) and empirical outcome data of tested business action types to produce a personalized business action model (e.g., as provided based on deploying selected business action types at Stage 140). The personalized business action types may identify a set of different business actions for different segments of a stakeholder base and situations in which each business action may be suggested (e.g., may represent a business action with a highest expected value among the set of different business actions). The set of business actions for each segment may be based the output of previous stages as well as on social media data, purchase data, or other demographic (or firmographic) data collected in any previous stage. Personalized business actions and associated expected values will be explained below in reference to FIGS. 13-15. Furthermore, training a personalized recommendation engine using machine learning may automatically discover stakeholder groups within a given stakeholder segment called micro-segments where business action recommendations can be optimized better than in the general population in the stakeholder segment. Micro-segmentation may implicitly define these stakeholder groups using stakeholder characteristics that may be more elaborate than more intuitive stakeholder segmentation based on standard stakeholder characteristics used to define stakeholder segments such as demographics and firmographics data.

At the “Recommend Personalized Business Action Using Trained Engine” stage 160, the personalized business action model may then be used by a personalized business action recommendation engine to recommend at least one personalized business action for at least one individual stakeholder using trained model and profile data associated with the at least one individual stakeholder. The personalized business action recommendation engine may access data regarding a particular stakeholder, e.g., data stored in a stakeholder profile, social media data, and/or purchase history data, and use the personalized business action model to generate a business action recommendation for a current stakeholder interaction that is part of an ongoing or new stakeholder interaction episode. Stage 160 may be running as a background stage to update the personalized business action recommendation as new data becomes available for training, in real-time or in an offline mode.

At the “Business Action Implementation & Outcome Measurement” stage 170, the system may measure and evaluate an outcome of a business action for an individual stakeholder for feeding back to the personalized business action model. For example, the recommended business action may be implemented (e.g., a discount offer may be made, additional information may be provided, or a different recommended intervention may be carried out) and a response to the business action may be received and/or an outcome of the business action or of the interaction episode may be identified. For example, at a particular stage of an interaction episode, additional information may be provided and no purchase made and, at a subsequent stage of the interaction episode a discount offer may be provided and a purchase made. During Stage 170, the response to each particular interaction may be recorded as well as the ordered set of interactions along with the outcome of the interaction episode (e.g., a purchase). This may be used along with other data regarding other interaction episodes, for example, to identify that a discount offer is more likely than additional information to result in a purchase and/or that the discount offer works more effectively after additional information has been presented than before. For example, the data collected during the “Business Action Implementation & Outcome Measurement” stage 170 may be fed back to the “Recommend Personalized Business Action Using Trained Engine” stage 160 to update the personalized business action model. In some aspects, the personalized business action model may use weighted business action to introduce some variability to allow data to be collected regarding different business actions or business action sequences for subsequent training.

FIG. 2 is a diagram of an example computing environment of the BE-based framework for optimal and personalized business decision making. The example computing environment is illustrated as an example architecture of a system implementing a machine-learning-based recommendation engine 220 (e.g., a personalized business action recommendation engine). As illustrated in FIG. 2, the machine-learning-based recommendation engine 220 may include a set of behavioral models in a behavioral model module 230, an agent-based modeling simulation module 240, a machine learning module 250, and a personalized business action recommendation module 260. The machine-learning-based recommendation engine 220 may further be in communication with a data repository 210 and a graphical user interface (GUI) 270 for presenting a recommendation to a user (e.g., B2C user 280a or B2B user 280b).

Data repository 210 may include many different types of data stored in different databases (or different data formats or different data sources) 210a-110l. The different types of data may include sales data relating to business transactions between stakeholders that may be stored in database 210a. The different types of data may include firmographic (or socioeconomic) data may be stored in database 210h and may include demographic information relating to specific firms or consumers (e.g., customers). The different types of data may include survey data regarding responses to surveys that may be stored in database 210c and stakeholder profile data stored in database 21d. Additionally, experiment data may be stored in database 210e and business action data may be stored in database 210f. Other types of stored data may include historical transactions data stored in database 210g, spatial-temporal data stored in database 210h, historical study data stored in database 210i, social data stored in database 210j, product data stored in database 210k, or operational data stored in database 210l. The data stored in data repository 210 may be accessed by machine-learning-based recommendation engine 220 to generate business action recommendations and/or for training a learning module (e.g., machine learning module 250 or other machine learning module, such as a neural network). Data repository 210 may be updated as new data is generated by one of interactions with stakeholders (e.g., surveys, purchases, interventions, projections, or other information related to a product or stakeholder).

Behavioral model module 230 may include different behavioral models, e.g., models 230a-230f, for different applications. For example, a first behavioral model may be used to recommend an optimal intervention strategy to boost consumer perceived value leading to increased sales. A second behavioral model may be used to de-bias forecasts made for capacity planning decisions in a supply chain to accurately forecast demands at multiple steps in a supply chain. In some aspects, more than one behavioral model may be used to generate a recommendation policy (e.g., a reinforcement learning policy, an intervention policy, an action policy, or other policy relevant to a specific business application). For example, a rational choice behavioral model 230a may be used to identify an expected behavior/response based on a rational customer (e.g., homo economicus) and a nudge behavioral model 230b may be used to generate an intervention (e.g., a change in how a product is presented to a customer) to increase a desired response. Other models may be used to fine tune the intervention or to generate interventions relating to other aspects of the product (e.g., the price).

The behavioral model module 230 may interact with a diagnosis module 290 that includes a behavior analysis module 291 and a survey design module 292. The survey design module 292 may be used to generate a behavioral-economics-informed survey. The behavioral-economics-infirmed survey may include at least one of a set of survey questions or a set of conjoint analysis questions, where the behavioral-economics-informed survey relates to at least one of attitudes towards a product, perceived attitudes of other people towards the product, an importance of different features of the product, or a value associated with one or more features of the product. The behavior analysis module 291 may analyze behavioral-economics-informed survey response data or historical interaction data related to a particular behavioral economics model (e.g., behavior models 230a to 230f) to generate recommended actions.

The agent-based modeling simulation module 240 may include a data collector 241 that may access data repository 210 to collect data for generating a model 244 that may be used to train the machine learning module 250. The agent-based modeling simulation module 240 may include an agent 242 that may represent a behavior model for an agent (consumer or business) that interacts with a data collector 241, a process scheduler 243, and a model 244. Model 244 may be informed by the agent 242 and the process scheduler 243. The process scheduler 243, in some aspects, controls a time duration associated with the model 244. For example, if a business timeline is a 90-day period, the process scheduler 243 may limit the model to a 90-day horizon to more closely match the application for which the machine learning module 250 is being trained.

The machine learning module 250 may include a gym environment 252 that interacts with the agent-based modeling simulation module 240 to receive simulated data for training the machine learning module 250. The gym environment 252 may interact with a utility module 251 that incorporates one of the behavior models 230a-230f. The utility module 251 may provide data related to the simulated data to the machine learning (ML) trainer 254 that may generate and/or update a recommendation policy stored in policy repository 253. In some aspects, the utility module 251 may access data from data repository 210, process the accessed data, and provide data related to the processed data to the ML trainer 254. The machine learning module 250, in some aspects, may include at least one of a reinforcement-learning-based recommendation engine, a statistical-regression-based recommendation engine, neural-network-based recommendation engine and the MIL trainer 254 may train the model 244 based on reinforcement-learning, statistical-regression, or neural-network training methods. For example, for a B2C use case, the ML trainer 254 may generate a recommendation policy that may associate data regarding different segments (e.g., microsegments identified by the ML trainer 254) of consumers with a set of interaction states and corresponding recommended interventions. The different consumer (or customer) segments. e.g., microsegments, may be identified by a neural network or other machine-learning algorithm trained to by the ML trainer 254 to identify consumer segments while the recommended interventions may be generated by a second machine-learning algorithm such as a reinforcement-learning-based algorithm. The recommendation policy may further be used by the agent-based modeling simulation module 240 to simulate a response to a customer interaction (based on an input customer-interaction state) and provide the response to the machine learning module 250 for training the recommendation policy.

The personalized business action recommendation module 260 may access data repository 210 to collect data relating to a stakeholder interaction and may access the policy repository 253 to apply to the data accessed from the data repository 210. The impact measurements 261 may include a set of responses to previous business actions. The impact measurements 261 may be associated with a set of business action types 263 (e.g., a set of possible interventions). The personalized recommendation 262 may be provided based on the business action types 263, the impact measurements 261, and a recommendation policy received from machine learning module 250. The personalized recommendation 262 may be provided to the B2C user 280a (e.g., a sales strategist or a product owner) or the B2B user 280b (e.g., capacity planner or a purchase manager) via the GUI 270.

FIG. 3 illustrates mappings of the generic 7-step method described in relation to FIG. 1 to individual use cases as will be described in more detail in relation to FIGS. 5 and 17 below. At a first “stakeholder group segmentation” stage 310, socio-economic data, firmographic data, sales data, and so on may be used to generate initial target segments and initial pricing models. The “stakeholder group segmentation” stage 310 when applied (1) to a B2C scenario may include identifying consumer segments based on demography data 312 and (2) to a B2B scenario may include identifying retailer segments 314. The initial target segmentation and initial pricing models may be used to inform a “survey and/or interview design and behavior analysis” stage 320. The “survey and/or interview design and behavior analysis” stage 320 may be applied to a B2C scenario by surveying consumers in each segment to gain insights into consumer attitudes toward products (e.g., sustainable products) at 322 while survey design may not be applicable at 324 to a B2B scenario for de-biasing forecasts. The “survey and/or interview design and behavior analysis” stage 320 may also be informed by data from past studies and includes an analysis of the survey responses. The survey may be designed to elicit information regarding behavioral factors (e.g., beliefs, values, environmental factors, and so on) and/or may be designed to compare preferences between two or more choices based on a comparison of features and prices (e.g., a conjoint analysis). The survey and/or behavior analysis may also be used to identify or generate pricing and demand models (e.g., related to a demand curve and/or price elasticity) and/or possible business actions. Some elements related to “survey and/or interview design and behavior analysis” stage 320 are discussed below in relation to FIGS. 6-8 pertaining to B2C use case as an example.

“Business action types selection for target segments” stage 330 may be informed by the “survey and/or interview design and behavior analysis” stage 320, product features, features of different stakeholder segments (e.g., identified during the “stakeholder group segmentation” stage 310), and feedback from subsequent stages (e.g., “business action types test and/or empirical evidence” stage 340). The “business action types selection for target segments” stage 330 may produce a set of best business action types and magnitude ranges of the business action types (e.g., amounts of discount). For a B2C scenario. “business action types selection for target segments” stage 330 may be realized, at 332, as selecting best business intervention types (action types, e.g., nudging, discounts, warranties, etc.) for each consumer segment based on the insights gained from 322 while the B2B scenario may not apply at 334 the “business action types selection for target segments” stage 330. The best business action types may be a set of business action types that maximize a profit or other metric based on a current state of an interaction episode and a set of characteristics of a customer. The best business action types may be produced based on a reinforcement learning module (or other machine learning component) and/or methodology.

Based on the current best business action types and magnitude ranges produced by the “business action type selection for target segments” stage 330 as well as a set of test customer profiles. A “business action types test and/or empirical evidence” stage 340 may generate an empirical outcome of the business action types test. The “business action types test and/or empirical evidence” stage 340 when applied (1) to a B2C scenario may include, for each segment, testing selected business intervention types on individual consumers and collecting their responses to interventions 342 and (2) to a B2B scenario may include collecting transaction data between the supplier and retailers that includes business decisions made and information shared as part of the transaction, and retailer profile data 344. In some aspects, the test stakeholder profiles may include stakeholder interaction data. The empirical outcomes of the testing may be fed back to “business action types selection for target segments” stage 330 (e.g., to be used to train a reinforcement learning module and/or update a training of the reinforcement learning module (or other machine learning module, neural network, or other similar module).

From the business action types identified at the “business action types selection for target segments” stage 330 and the empirical data generated by the “business action types test and/or empirical evidence” stage 340, the “train personalized business action recommendation engine” stage 350 may produce a personalized business action model. Training a personalized business action recommendation engine may include, for a B2C scenario, using collected business-consumer interaction data to train a personalized intervention recommendation engine (e.g., a RL policy) 352. For a 132 scenario, training the personalized business action recommendation engine may include selecting and fitting a personalized predictive model of supplier-retailer trust to the collected data using maximum likelihood estimation methods at 354. The personalized business action types may identify a set of different business actions for different segments of a stakeholder base and situations in which each business action may be suggested (e.g., may represent a business action with a highest expected value among the set of different business actions). The set of business actions for each segment may be based the output of previous stages as well as on social media data, purchase data, or other demographic (or firmographic) data collected in any previous stage. Personalized business actions and associated expected values will be explained below in reference to FIGS. 4-15.

The personalized business action model may then be used by a personalized business action recommendation engine at a “recommend personalized business action using trained engine” stage 360. At the “recommend personalized business action using trained engine” stage 360, the personalized business action recommendation engine may access data regarding a particular stakeholder, e.g., data stored in a stakeholder profile, social media data, and/or purchase history data, and use the personalized business action model to generate a business action recommendation for a current stakeholder interaction that is part of an ongoing or new stakeholder interaction episode. In a B2C scenario, recommending personalized business action using a trained engine may include using trained RL policy to recommend personalized intervention for individual consumers based on their current state at 362. In a B2B scenario, recommending personalized business action using a trained engine may include using personalized models of trust to de-bias information shared and recommend best decision to plan supplier capacity at 364. The “recommend personalized business action using trained engine” stage 360 may be running as a background stage to update the personalized business action recommendation as new data becomes available for training.

At “business action implementation and outcome measurement” stage 370, the recommended business action may be implemented (e.g., a discount offer may be made, additional information may be provided, or a different recommended intervention may be carried out). Additionally, “business action implementation and outcome measurement” stage 370 may include receiving a response to the business action and/or identifying an outcome of the business action or of the interaction episode. For example, at a particular stage of an interaction episode additional information may be provided and no purchase made and, at a subsequent stage of the interaction episode a discount offer may be provided and a purchase made. During the “business action implementation and outcome measurement” stage 370, the response to each particular interaction may be recorded as well as the ordered set of interactions along with the outcome of the interaction episode (e.g., a purchase). This may be used along with other data regarding other interaction episodes, for example, to identify that a discount offer is more likely than additional information to result in a purchase and/or that the discount offer works more effectively after additional information has been presented than before. For example, the data collected during the “business action implementation and outcome measurement” stage 370 may be fed back to the “recommend personalized business action using trained engine” stage 360 to update the personalized business action model. In some aspects, the personalized business action model may use weighted business action to introduce some variability to allow data to be collected regarding different business actions or business action sequences for subsequent training. In a B2C scenario, business action implementation and outcome measurement may include deploying a trained RL policy and evaluate total RL rewards at 372. In a B2B scenario, business action implementation and outcome measurement may include deploying de-biasing method deriving from personalized trust model and evaluate cost savings at 374.

As an example of a B2C use case, FIGS. 4-15 may discuss the machine-learning-based recommendation engine implementing a personalized intervention engine in relation to home energy storage systems (HESS). For example, the current U.S. market for HESS is dominated by all-new (conventional) battery packs; however, many companies have started working on storage products made of end-of-life Electric Vehicle (EV) batteries. An EV battery is no longer usable in an automotive application after about eight years or about 150,000 km, even though it still has around 80% of its initial capacity left. Used EV batteries can further be repurposed in second-life applications such as home energy storage solutions.

Consumer behavior plays a major role in success of a repurposed product such as home energy storage system made of repurposed EV battery cells. Since consumers may perceive a repurposed product inferior to a conventional product, right incentives must be offered, and quality concerns should be adequately addressed. Our invention helps find optimal intervention model to boost consumer perceived value and maximize profit. The interventions discussed below may be specific to this use case, but additional or alternative interventions may be identified in other use cases as appropriate.

Surveys have shown that customers' attitude towards storage products based on repurposed batteries vary widely depending on factors such as customers' age, level of education, and energy needs. Examples of customer's attitude include quality and reliability concerns, care for natural resource conservations, and cost consciousness. To market these products successfully it may be beneficial to understand customer behavioral biases enough to formulate intervention strategies that can incentivize customers to purchase these HESS products based on repurposed batteries. FIGS. 4-15 discuss how to personalize these interventions to individual customers to maximize business key performance indicators.

FIG. 4 illustrates a set of inputs to a consumer decision that may be considered in generating a set of interventions and/or models for a use case related to solar power and storage. A product cost 410 may be based on the cost of the inputs (e.g., the cost of solar panels as well as a battery). A service cost 412, in some aspects, may be based on the cost to the supplier of servicing the product during the lifecycle of the product, e.g., an installation cost and servicing associated with a provided warranty. The product cost and the service cost may together inform a price 420 for the producer.

The perceived value 440 of a product may be based on customer needs 430, customer convenience 432, a perceived quality 434, and a possession hurdle 436 among other relevant factors. For example, in the use case related to solar power, customer needs 430 may include the frequency of power outages, current power consumption, and product feature coverage. Customer convenience 432 may be informed by the product availability and service locations. A perceived quality 434 may be based on a risk of failure and maintenance requirements and a possession hurdle 436 may be based on an initial investment requirement and/or an income level of the consumer. While example factors have been discussed above for a particular use case, other factors may be considered in other use cases.

The perceived value 440 may further be based on a set of interventions 442 that may lead to one of a set of consumer actions 444. The set of interventions 442 may include information campaigns to change a perception of the value of the product, warranty offers to increase the value of the product, financing offers (e.g., to overcome a possession hurdle), or discount offers. The consumer actions 444 may include no action, an inquiry about an offer, or a purchase. A profit 450 may be based on the price 420 (e.g., a price to the producer) and the perceived value 440 (e.g., a price that a customer is willing to pay).

FIG. 5 illustrates an implementation of the stages illustrated in FIG. 1 for a first use case (B2C use case). For example, a business optimization problem 505 may be defined. Based on the business optimization problem 505 a set of segments to focus on may be identified during “customer segment identification” step 510 similarly to “stakeholder group segmentation” stage 110. The customer segments identified during “customer segment identification” step 510 may be an initial set of customer segments based on demographic data, customer profiles, purchase data, and/or an initial model. FIG. 6 illustrates an example consumer demographics profile data 600 collected for the B2C use case related to incentivizing consumers to buy energy storage products built out of repurposed batteries. Customer profile data 600 may include fields for location different levels of granularity (e.g., state field 601 and county field 602). Customer profile data 600 may further include demographic data including the highest level of education (e.g., college education field 603) and employment status (e.g., employment field 604). Other fields of the Customer profile data 600 may include product specific fields (e.g., outage duration field 605 and energy consumption field 606). Additional fields 607 may include other types of information deemed relevant by a user of the system.

After a set of customer segments are identified during “customer segment identification” step 510, a set of behavioral-economics-guided customer surveys may be designed and provided to potential customers at “survey design and data collection” step 520. The “survey design and data collection” step 520 may further include collecting data from the surveys. FIG. 6 further illustrates an example set of behavioral questions 620 and a conjoint analysis 640 that may be produced during “survey design and data collection” step 520. For example, behavioral questions 620 may include questions relating to need for a product (e.g., question 621), attitudes towards a product in general (e.g., questions 622 and/or 623), perceived social factors and/or considerations (e.g., question 624), and individual preferences and/or values (e.g., questions 625 and 626) among other issues or considerations that may affect a customer's decision to purchase a product. Additionally, a conjoint analysis question 640 may be performed in which a customer is presented with two or more options (e.g., conventional battery 641 or repurposed battery 643) and selects a best option (or ranks a set of more than two options). Different conjoint analysis questions 640 may be provided to different customers (e.g., for A/B testing) or to a same customer (e.g., in sequence) to determine a ranking of factors and/or a combination of factors that most affect a customer's decision.

After the surveys are provided and data is collected a set of behavioral-economics-guided intervention types based on the data and behavioral economic concepts may be generated during “intervention types selection” step 530. These business intervention types may include one or more of nudging and providing information regarding the product, offering a small discount, offering a large discount, or other similar intervention types. FIG. 7 illustrates a set of business intervention types 700 for an example business optimization problem relating to the introduction of a repurposed battery storage product and a set of possible customer responses types for the example use case. Each intervention type may be associated with a code for encoding data. For example, each intervention type (e.g., information campaign 710, small discount 720, or large discount 730) may be associated with an offer code 701 (e.g., 1, 2, or 3) and a description of the offer 702. FIG. 7 also illustrates a set of possible consumer response types 740 for an example B2C use case relating to the sale of a battery for HESS in which both conventional (e.g., new storage cells) products and repurposed battery (e.g., repurposed electric vehicle storage cells) products are offered. For example, possible response types 740 may include “no purchase” 750, “purchase of conventional battery product” 760, and “purchase of repurposed battery product” 770, each associated with a response codes 741 (e.g., response codes 0, 1, and 2, respectively) and a description 742.

In some aspects, the data collected may be used to define demand curves that are used in behavioral models. FIG. 8A illustrates an example demand curve chart 800 identifying a demand (in units of percent purchased) at different prices per kWh (e.g., cost per kWh of battery storage) for the repurposed battery example discussed in relation to FIGS. 4-7. The demand curve chart 800 illustrates a data point 802 that represents a misaligned pricing and/or promotion (e.g., a pricing or promotion that loses market share, or decreases profit compared to other points on the curve). Demand curve chart 800 also illustrates (1) a pricing plateau 804 (e.g., between $800/kWh and $700/kWh) indicating a set of price points at which customers are relatively sensitive to the cost of the product and (2) a zone of indifference 806 indicating a set of price points at which customers are indifferent to changes in price (e.g., at a market saturation). FIG. 8B illustrates an example demand curve 820 for electricity with an example price of $300014 kWH and a demand 822 of approximately 30,000 kWh indicating that demand 824 may contract to approximately 20,000 kWh if a price increases to $4000/4 kWh and that demand 826 may expand to approximately 50,000 kWh if a price decreases to $2000/4 kWh. These demand curves for the product and one or more related commodities may be based on collected data or may be initially assumed to create an initial model for testing and/or training a set of behavioral interventions before data collection.

Ater generating the set of business intervention types, in an exploration phase 535, data may also be collected that captures how customers respond to different types of intervention during an entire interaction episode. FIG. 9 illustrates an example interaction episode where business interventions and customer responses are interleaved. The example interaction episode includes an episode start 902 that may indicate a first contact with a customer (e.g., a phone call, email, customer inquiry, or other interaction). The interaction may include a set of business interventions 910 (e.g., as described in relation to selected business intervention types 700). For example, the interaction episode may include a first offer 912 (e.g., a nudge or product benefit information), a second offer 914 (e.g., small discount) and a third offer 916 (e.g., a large discount). The interaction may also include a set of customer responses 920 that include a response to the first offer 922 (e.g., customer doing nothing), a response to the second offer 924 (e.g., customer still doing nothing), and a response to the third offer 926 (e.g., purchase of repurposed battery product). The interaction episode may be terminated at episode end 932 based on an expiration of a pre-configured time or may be terminated based on a purchase or installation of a purchased product.

The exploration phase 535 may include testing the market and collecting market-response data 540. The collected data may be used as training data for estimating an action-value function which may be used to generate a recommendation policy (e.g., a reinforcement learning policy that suggests optimal business interventions). In some aspects, an Agent-Based Modeling Simulator may be used to simulate customer response behaviors in a simulated market (e.g., elements 1120, 1130, and 1140 and elements 1220, 1230, and 1240 in the dashed boxes of FIGS. 11 and 12, respectively) before sufficient real-world data is collected for training and/or generating the recommendation policy. In a real-world setting, the latter will be replaced by the real market segments the business has chosen to promote its new product.

FIG. 10 is a flow diagram 1000 illustrating an example of customer's purchasing behavior in response to business interventions, where the purchasing behavior is sufficiently formalized that it can be executed in an agent-based simulation engine to simulate customers' responses. The output of the simulated customer behavior may be used to train and/or estimate an action-value function (e.g., a value associated with each intervention for a given state of an interaction episode and for a particular customer segment). FIG. 11 conceptually illustrates how customer response data can be synthesized by injecting a random intervention policy to an agent-based modeling market simulator. The synthetic customer response data generated by the simulator will be used later to train an optimized intervention policy. For example. FIG. 11 illustrates a method to generate customer response data that uses an agent-based modeling (ABM) market simulator 1120 (e.g., implementing flow diagram 1000 of FIG. 10), with the injection of a random business intervention policy (which suggests business interventions at random), and collects interaction data for the entire simulated episode. The method of flow diagram 1000 may be performed by the ABM market simulator 1120. At 1010, the ABM market simulator may perform a ‘coin flip’ (or other randomization) with a pre-configured success rate (e.g., a 100% success rate). The initial coin flip may represent a first set of interventions provided by default. If the ‘coin flip’ at 1010 fails, a response may be generated from a set of three responses (e.g., no purchase, purchase conventional product, or purchase repurposed product as in possible responses 740 of FIG. 7). The response may be selected based on a weight associated with each response type. For example, the probability distribution 1015 may be associated with weights (e.g., [0.70, 0.15, 0.15]) for a set of responses or response codes (e.g., 0, 1, 2 as defined in FIG. 7).

If the ‘coin flip’ is successful, the method may determine, at 1020, whether the set of interventions selected by the intervention policy so tar includes a first offer (e.g., O₁) associated with an offer code (e.g., ‘2’). An offer O₂ with code ‘0’ represents the fact that the second offer has not yet been made. If the set of interventions satisfies a first condition (e.g., O₁=2 & O₂=2), a customer response may be selected based on a weight associated with each response type. For example, the probability distribution 1025 may be associated with weights (e.g., [0.85, 0, 0.15]) for a set of responses or response codes (e.g., 0, 1, 2 as defined in FIG. 7).

If the set of interventions does not satisfy the first condition (e.g., O₁=2 & O₂=0), the method may determine, at 1030, whether the set of interventions selected by the intervention policy satisfies a second condition (e.g., O₁=2 & O₂°=3 OR O₂=2 & O₃=3 OR O₁=2 & O₃=3). If the set of interventions meet the second condition, a response may be generated based on a weight associated with each response type. For example, the probability distribution 1035 may be associated with weights (e.g., [0.70, 0, 0.30]) for a set of responses or response codes (e.g., 0, 1, 2 as defined in FIG. 7).

If the set of interventions does not satisfy the second condition (e.g., O₁=2 & O₂=3 O₂=2 & O₃=3 OR O₁=2 & O₃=3), the method may determine, at 1040, whether the set of interventions selected by the intervention policy satisfies a third condition (e.g., O₁=1 & O₂=0). If the set of interventions meet the third condition, a response may be generated based on a weight associated with each response type. For example, the probability distribution 1045 may be associated with weights (e.g., [0.80, 0.10, 0.10]) for a set of responses or response codes (e.g., 0, 1, 2 as defined in FIG. 7).

If the set of interventions does not satisfy the third condition (e.g., O₁=1 & O₂=0), the method may determine, at 1050, whether the set of interventions selected by the intervention policy satisfies a fourth condition (e.g., O₁=1 & O₂=3 OR O₂=1 & O₃=3 OR O₁=1 & O₃=3). If the set of interventions meet the fourth condition, a response may be generated based on a weight associated with each response type. For example, the probability distribution 1055 may be associated with weights (e.g., [0.80, .20, 0]) for a set of responses or response codes (e.g., 0, 1, 2 as defined in FIG. 7).

If the set of interventions does not satisfy the fourth condition (e.g., O₁=1 & O₂=3 OR O₂=1 & O₃=3 OR O₁=1 & O₃=3), the method may determine, at 1060, whether the set of interventions selected by the intervention policy satisfies a fifth condition (e.g., O₁=1 & O₂=2 & O₃=3). If the set of interventions meet the fifth condition, a response may be generated based on a weight associated with each response type. For example, the probability distribution 1065 may be associated with weights (e.g., [0.70, 0.05, 0.25]) for a set of responses or response codes (e.g., 0, 1, 2 as defined in FIG. 7). If the set of interventions does not satisfy the fourth condition (e.g., O₁=1 & O₂=2 & O₃=3), a response may be generated based on a weight associated with each response type. For example, the probability distribution 1075 may be associated with weights (e.g., [0.90, 0.05, 0.05]) for a set of responses or response codes (e.g., 0, 1, 2 as defined in FIG. 7). In other aspects, the method of simulating customer behavior based on an intervention policy may be based on a lookup table that associates different sets of interventions with sets of responses that may be selected based on a set of associated weights. In some aspects, a first intervention may be selected and a response may be generated and subsequent interventions and responses may be made based on the previous interventions and responses.

FIG. 11 illustrates that the ABM market simulator 1120 takes as inputs a consumer home energy storage systems (HESS) purchase behavior model 1130 and a demographics generator 1140, and randomly simulates customers with a set of demographic attributes like 1152. The simulator 1120 also takes as input an intervention policy which is applied to each customer separately. Since the simulator 1120 is used here to generated customer response data that will be used later for training purposes, we choose to use a random intervention policy 1110 which recommends interventions in a random fashion, in order to discover customer responses in any situation. Customer responses are generated according to the HESS purchase behavior model 1130 using the weights associated with each determination 1010-1060 (e.g., the weights 1015-1075 as shown in FIG. 10) as probabilities to generate the corresponding response types.

Based on the inputs from the random intervention policy 1110, the consumer HESS purchase behavioral model 1130, and the demographics generator 1140, the ABM market simulator 1120 may generate customer response data 1150 (e.g., simulated customer interaction data) that includes demographic data 1152 and a set of interaction episode data 1154. The set of interaction episode data 1154 may identify a set of offers/interventions and a set of responses along with the timing of each. The generated data 1150 may be used along with additional sets of generated data to train a reinforcement learning policy in the absence of real-world data.

Returning to the discussion of FIG. 5, based on either simulated data or collected data generated during an exploration phase 535, an intervention policy (e.g., a recommendation policy generated by a machine-learning-based recommendation engine) may be generated during an optimization phase 545 where the data collected during the exploration phase is used to train a recommendation policy that recommends the best intervention in any given state, as indicated in “train a personalized intervention recommendation engine” step 550. The state may include customer demographic data (e.g., demographic data that is part of customer profile) and data regarding the interactions in a current interaction episode that are used to generate a personalized recommendation. The personalized intervention policy (e.g., optimized interventions 560) that results from the optimization phase 545 is then deployed in an exploitation phase 555 to the same ABM market simulator 1120, 1130, 1140 as used during the exploration phase.

FIG. 12 illustrates how reinforcement learning can be used to optimize/personalize a business intervention policy, which can then be deployed, tested and evaluated in the same ABM market simulator used for data generation. FIG. 12 illustrates that during the optimization phase, data (e.g., customer response data 1250) may be provided to a reinforcement learning (RL) action-value based policy optimizer 1260 (e.g., as an example of a machine-learning-based recommendation engine) along with information related to the coding of demographic and state data (e.g., RL state enriched with demographic features 1270). Based on the collected (or simulated) data, the RL action-value based policy optimizer 1260 may generate a personalized intervention policy 1210. During the exploitation phase, the personalized intervention policy 1210 may be tested using the ABM market simulator 1220, the consumer HESS purchase behavioral model 1230 and the demographics generator 1240. The personalized intervention policy 1210 may produce business outcomes 1280 and a distribution of interventions 1290 that may be substantially better when compared with a baseline where a random intervention policy is used.

FIG. 13 is an example of a particular reinforcement learning technique that tries to estimate an action-value function (Q) 1305 that indicates a value (e.g., values 1307-1309) associated with a state 1300 and a particular intervention (e.g., interventions 1301-1303). The action-value function 1305 may be used to determine an intervention for an (optimized) personalized intervention policy 1310. For example, given a state 1300, the action-value function 1305 may output (1) a value 1307 of ‘1.5’ for an information campaign 1301, (2) a value 1308 of ‘0.5’ for a small discount 1302, and (3) a value 1309 of ‘1.0’ for a large discount 1303. The output value based on a given state and input intervention (e.g., action) may be based on the outcomes of the collected data (e.g., initially based on a first set of simulated data and updated in real time or in a batch mode as data from actual customer interactions is received). For example, if an interaction episode in which a first intervention that is an information campaign leads to 1.5 times (or 3 times) the sales (or profits) of an interaction episode in which the first interaction is a large discount (or a small discount), the associated values may be ‘1.5’ and ‘1.0’ (and ‘0.5’) respectively. Based on the relative values (e.g., the expected total rewards in some common unit) associated with the different interactions, a personalized intervention policy 1310 may identify an intervention (e.g., information campaign 1301) associated with the highest relative value as the intervention associated with a corresponding state (e.g., 1300).

FIG. 14 illustrates a flow diagram 1400 of running a simulation experiment where an injected business intervention policy is applied to simulated customers with given purchasing behaviors. This simulation experiment can be used to both generate synthetic customer response data and evaluate the effectiveness of a given business intervention policy. The process may be performed by an ABM market simulator (e.g., ABM market simulator 1220) which takes as inputs at 1410 an intervention policy (π) and a customer response model or purchasing behavior model (M). For example, referring to FIGS. 12 and 13, the random intervention policy 1110 or the personalized intervention policy 1210 and the consumer HESS purchase behavioral model 1130 or 1230 may be used by ABM market simulator 1120 or 1220.

After identifying the intervention policy and customer response model at 1410, the ABM market simulator may, at 1420, create a collection of customer agents with demographic data and an initially empty trajectory. For each customer agent, the demographic data may be used by the ABM market simulator to define a state including an empty trajectory (e.g., a trajectory including no interventions/offers or customer responses). For example, referring to FIGS. 11 and 12, the ABM market simulator 1120 or 1220 may receive a set of demographic data from the demographics generator 1140 or 1240.

For each customer agent, the ABM market simulator may, at 1430, use policy π to select an intervention based on a state of the interaction episode. The state of the interaction episode may include demographic data as well as a trajectory data related to interventions and responses in an interaction episode so far. The state may be updated based on the selected intervention. For example, referring to FIGS. 11 and 12, the ABM market simulator 1120 or 1220 may select an intervention based on the state of the interaction episode based on the random intervention policy 1110 or the personalized intervention policy 1210.

Based on the intervention selected at 1430, the customer response model (M) may be used by the ABM market simulator, at 1440, to select a response to the selected intervention for a given customer agent. The customer response model may include a response probability distribution (e.g., probability distributions 1015, 1025, 1035, 1045, 1055, 1065, or 1075 of FIG. 10) for each interaction episode state that may be used to determine a selected response to the intervention selected at 1430. The ABM market simulator may then update the state of the interaction episode. For example, referring to FIGS. 11 and 12, the consumer HESS purchase behavioral model 1130 or 1230 may select a response to an intervention based on the state of the interaction episode selected based on the random intervention policy 1110 or the personalized intervention policy 1210.

At 1450, the ABM market simulator may determine if the interaction episode has ended. For example, the ABM market simulator may determine (1) if a purchase was made, (2) if the set of interventions has been exhausted, or (3) some other condition for ending an interaction episode has been met (e.g., an information campaign and large discount have been offered, such that offering a small discount is not expected to lead to a purchase). If the interaction episode has not ended, the ABM market simulator may select, at 1430, a next intervention based on the current state of the interaction episode and continue as above.

If, at 1450, the ABM market simulator determines that the interaction episode has ended, the ABM market simulator may determine, at 1460, whether to end the simulation. For example, a simulation may end after a configured number of iterations of steps 1420 to 1450 have been performed (e.g., after a configured number of customer response data has been generated). If the ABM market simulator determines not to end the simulation, the ABM market simulator may create, at 1420, an additional customer agent with demographic data and an initially empty trajectory and continue as above. If the ABM market simulator determines to end the simulation, the process may end and the ABM market simulator may collect and output the generated simulation data. If the random intervention policy 1110 is chosen for π, the generated data will be used to train a reinforcement learning action-value based policy optimizer. If the personalized intervention policy 1210 is chosen for z, the generated data will be analyzed to validate and assess the performance of the personalized intervention policy in terms of business outcomes.

FIG. 15 is a flow diagram of a method 1500 for iteratively improving the estimation of an action-value function Q as described in relation to FIG. 13. The method may be performed by a RL action value-bused policy optimizer (e.g., RL, action-value based policy optimizer 1260). At 1510, a Q-value for each pair of state and action may be set equal to a constant (e.g., Q(s,a)=1). For example, referring to FIG. 13, each action value function for each pair of state 1300 and intervention (or action) 1301 to 1303 may be set equal to 1.

At 1520, the RL action value-based policy optimizer may initialize a training data set (S). The training data set may be an empty set that is populated by a set of collected data by the RL action value-based policy optimizer. The training data set may include multiple data sets relating a state (s), an action/intervention (a), a reward (r), and a next state (s′) (e.g., S={(s, a, r, s′)}). For each data point (e.g., (s, a, r, s′)) a particular state and action pair (e.g., (s, a)) may be associated with an induced value (e.g., (Q, r, s′)). In some aspects, the induced value is defined to be equal to the reward, r, plus a maximum value of Q based on the next state, s′, (e.g., induced value(Q, r, s′)=reward+MAX_{action} Q(s, a)).

After initializing the training set at 1520, the RL action value-based policy optimizer may fit, at 1530, the training set data using a regression model. The fitting may be based on a batch-mode RL policy optimization method (e.g., a Fitted Q-Iteration) that estimates an action-value function (e.g., Q(s,a)→value) that measures how good it is for the business to perform action ‘a’ in a given state ‘s’ in terms of future rewards to be expected. The RL action value-based policy optimizer may, at 1540, update the action-value function (e.g., Q(s, a)) based on the regression model.

After updating the action-value function at 1540, the RL action value-based policy optimizer may determine, at 1550, if the action-value function has converged. The convergence may be measured based on whether the action-value function changes more than a threshold amount between batches or as more data is processed. If the RL action value-based policy optimizer determines that the action-value function has not converged, the RL action value-based policy optimizer may initiate an additional training run beginning at 1520 and continuing to 1550. If the RL action value-based policy optimizer determines that the action-value function has converged, the process may end and a policy may be generated based on the converged action-value function. For example, a policy, π, may be defined by associating an action (or intervention) with a state (e.g., π(state) ARGMAX_{action} Q(state, action)).

As discussed in relation to FIGS. 1-15, the method, apparatus, and system may be used in a B2C use case to determine the right market segments for circular economy products such as HESS products based on repurposed batteries. For example, surveys may be developed to gather data on consumer attitudes toward and preferences and biases for a sustainable product and a competing conventional products. The data may then be analyzed based on behavioral economics (BE) models to account for deviations from economic model-based choices. The survey data may further be used to identify relevant intervention types and potential intervention ordering constraints (a sequence of interventions presented to a customer).

A reinforcement learning (RL) technique may be used to develop an optimized intervention policy. Price elasticity and demand curve of products, in some aspects, may be used to guide the reward selection for RL. When BE models of customers are available, an approach using an Agent-Based Modeling (ABM) system to simulate customer responses to interventions may be used to train the RL policy optimizer. In such aspects, intervention policies may be learned by a RL trainer that interfaces with the ABM simulator. While the above example was discussed in terms of a RL technique for training the personalized intervention engine (i.e., an example machine-learning-based recommendation engine), other types of machine-learning-based training and processing (e.g., neural networks, statistical regressions, or other machine-trained algorithms capable of accepting an input state and outputting a recommendation) may be used in the example or in other applications.

While qualitative BE models of consumer intervention outcomes can be developed, formulating accurate quantitative models for intervention outcomes, in some aspects, can be challenging. In the absence of models, responses may be collected directly from consumers as a result of applying various intervention sequences. Implicit in the data thus collected is BE information about consumers, which may be leveraged to learn, in an off-line fashion, intervention sequences that optimize given business outcomes. Based on the collected data consumer features (e.g., demographics, purchase history, social media, and other consumer data that is readily accessible) may be used to personalize intervention policy by automatically discover micro-segments of consumers with and associating them with a personalized intervention policy for an optimal business outcome.

FIG. 16 is a call flow diagram 1600 of a second example use case of a 2-participant supply chain related to debiasing demand forecasts. Call flow diagram 1600 begins by having a retailer 1610 provide an initial demand forecast 1630 to a supplier 1620. The initial demand may be an inflated forecast to ensure that the retailer can obtain supplies as needed even if the supplier will be disadvantaged by building out excess capacity or producing too much of a product. Based on the initial demand forecast 1630, the supplier 1620 may build out capacity or produce inventory 1640.

A retailer 1610 may then provide a formal order 1650 to the supplier 1620. As mentioned above, the formal order may not be the same as the initial forecast and may be expected to be less than the forecast. The supplier 1620 may then fulfill the order by providing the retailer 1610 with the ordered product 1660. This interaction may be performed at many levels of a supply chain with each interaction between a retailer and supplier introducing additional uncertainty and room for costly errors based on capacity planning decisions.

FIG. 17 illustrates an implementation of the stages illustrated in FIG. 3 for a second, B2B use case relating to debiasing demand forecasts. For example, a business optimization problem 1705 of optimizing capacity decisions may be defined. Based on the business optimization problem 1705 a set of retailer segments to focus on may be identified during “retailer segment identification” step 1710 similarly to “stakeholder group segmentation” stage 310. The retailer segments identified during “retailer segment identification” step 1710 may be an initial set of retailer segments based on firmographic data, retailer profiles, transaction data, and/or an initial model. FIG. 1g illustrates an architecture for a forecast debiasing system based on a behavioral economics model of trust in supplier-retailer information sharing. FIG. 18 includes an example transaction data 1810 for the use case related to debiasing demand forecasts. Transaction data 1810 may include fields for a supplier identity, a retailer identity, a period, a product, a wholesale price, a retail price, a forecast shared by a retailer, an actual order associated with the forecast.

The transaction data 1810 may further be informed by collecting firmographic data related to one or more retailers during “firmographic data collection” step 1720. The firmographic data may include characteristics of the firm such as a firm size and a related product or set of products. Additionally, historical transaction data may be collected related to previous forecasts and actual orders during “historical transaction data collection” step 1730. The “firmographic data collection” step 1720 and the “historical transaction data collection” step 1730 may make up an exploration phase 1735.

After the exploration phase 1735, an optimization phase 1745 may begin in which a behavioral economics (BE), or trust, model for the debiasing operations may be selected during a “trust model selection” step 1740. For example, referring to FIG. 18, a supplier-retailer trust model for information sharing may be selected from a BE model library 1820. Based on the BE model selected during the “trust model selection” step 1740 (trust model in this case) and the data collected during the exploration phase 1735, a set of parameters of the selected BE model may be trained (e.g., fitted) based on the data during “Fitting Trust Model Parameters to Data” step 1750. For example, referring to FIG. 18, the supplier-retailer trust model for information sharing selected from the BE model library 1820 and the transaction data 1810 may be provided to a parametric model optimizer 1830 (i.e., an example of a machine-learning-based recommendation engine) for training and/or fitting the set of parameters. FIG. 19 is a flow diagram for a parametric BE model optimization 1900, an associated data schema 1950 for data used to fit the model, and the model parameters 1960 and 1970. The parametric model optimization 1900 may be performed by a parametric model optimizer (e.g., parametric model optimizer 1830). At 1910, the parametric model optimizer may retrieve a trust model from a BE model library and a dataset, S, for model fitting. The trust model, in some aspects, may be related to the form indicated in trust model parameters 1960. For example, a probability distribution Pr(Report, Info)(where ‘Report’ is a reported forecast provided by a retailer to a supplier and ‘Info’ is an actual forecast known to a retailer) based on the utility function U(Report, Info) of the retailer reporting an accurate forecast may be retrieved. The probability distribution may be based on a bounded rationality parameter, γ, a profit-based parameter, a1, a trust-worthiness for under-reporting parameter, a2, and a trust-worthiness for over-reporting parameter, a3.

At 1920, the parametric model optimizer may use the retrieved data set, S, and the Pr(Report, Info) to define a likelihood function based on the parameters γ, a1, a2, and a3, e.g., a log-likelihood function LLH (γ, a1, a2, a3), for the fit of the probability distribution to the data set, S (e.g., as an example of a statistical-regression-based algorithm implemented by a statistical-regression-based recommendation engine). The probability distribution, in some aspects, may identify a probability distribution for a value of a forecast known to a retailer (‘Info’) based on a given reported forecast value (‘Report’) and firmographic data. The probability distribution, in some aspects, may identify a probability of a retailer choosing to provide the forecast (‘Report’) to the supplier, given that the retailer knows the real forecast (‘Info’). The probability distribution may be specified in Logit Quantal Response Equilibrium formulation using U(Report, Info) as the utility and the parameter, γ, as a bounded rationality parameter. In some aspects, the likelihood function (e.g., LLH (γ, a1, a2, a3)) identifies a likelihood that the data points in the data set, S, are from the probability distribution.

Finally, at 1930, the parametric model optimizer may estimate the optimized behavior parameters of the behavioral model. In some aspects, the optimized behavior parameters may be estimated using a maximum likelihood estimator (MLE) method. For example, in some aspects, the parameters may be optimized by solving Argmax (LLH(γ, a1, a2, a3)). The output of the parametric model optimization 1900 may be a set of optimized parameters for debiasing forecast received from a retailer based on a selected BE model (e.g., supplier-retailer trust model for information sharing).

After optimizing the parameters for the behavioral model, the parameters may be tested during the “debiasing result testing” step 1760. The testing may be performed by an inference to de-bias reported forecast module 1850 based on test data 1815 (which, in some aspects, may be from a same data set as the transaction data 1810 used to train the behavioral model). The inference to de-bias reported forecast module 1850 may further be configured to output a de-biasing prediction interval graph 1860 and/or a de-biasing reported forecast graph 1870.

FIG. 20 is a flow diagram for a shared information de-biasing inference 2000, an associated data schema 2050, and model parameters 2060 and 2070 (similar to data schema 1950 and model parameters 1960 and 1970). The shared information de-biasing inference 2000 may be performed by an inference to de-bias reported forecast module 1850. At 2010, the inference to de-bias reported forecast module 1850 may receive a forecast from a retailer (e.g., a ‘Report’) and a probability distribution tom the optimized BE model based on a data set. For example, referring to FIG. 18, the inference to de-bias reported forecast module 1850 may receive transaction data 1815 and a probability distribution from the model with optimized behavioral parameters 1840. In some aspects, the model with optimized behavioral parameters 1840 is a de-biasing policy that takes an input state (e.g., a received order associated with a particular customer) and outputs a de-biased output (e.g., a business action recommendation to build out capacity for the de-biased output). The optimized behavioral parameters may, in some aspects, be derived based on a statistical-regression-based recommendation engine for de-biasing projection data received from at least one retailer. The statistical-regression-based recommendation engine may be trained based on at least one of (1) a trust model (e.g., trust model 1960 or 2060) or (2) a comparison of historical projection data received from the at least one retailer and received outcome data associated with the historical projection data.

At 2020, the inference to de-bias reported forecast module 1850 may derive a value (or probability distribution) for Pr(Report, Info) using Bayes formula. For example, a prior Pr(Info) may be estimated from data and a prior Pr(Report) may be derived using the law of total probability and the probability distribution may be calculated based on the derived values of Pr(Info) and Pr(Report).

Finally, at 2030, the inference to de-bias reported forecast module 1850 may determine an expected range of the forecast known to the retailer based on the reported forecast. For example, an expected value (p) for the forecast known to the retailer (e.g., Info) based on the reported forecast (e.g., Report) and a standard error (or standard deviation, a) may be calculated and a range of values may be identified as likely to include the value for ‘Info’. The range may be calculated, in some aspects, as the expected value plus or minus some factor times the standard deviation (e.g., [μ-1.96σ, μ+1.96 σ]) to capture the real value of Info with a particular percent certainty (e.g., 95%).

After the optimization phase 1745, the optimized parameters may be used to de-bias a received report in “de-biasing result derivation” step 1770 in an exploitation phase 1775. The de-biased result may be personalized to a particular firm based on historical reporting and ordering data of the firm and the behavioral model selected during “trust model selection” step 1740. The de-biased shared (reported) information 1780 may then be used to guide a capacity decision based on the more accurate de-biased information during an exploitation phase.

FIG. 21 is a flow diagram of a method for providing personalized behavioral intervention recommendations when customer interaction data needed for training is not available in real life but could be synthesized through simulation. The method may be performed by a machine-learning-based recommendation engine or a system that includes a machine-learning-based recommendation engine (e.g., a system illustrated in FIGS. 2 and 12). At 2110, the system may determine initial segments based on stakeholder needs and product benefits and develop initial pricing and demand models collect data relating. Determining the initial segments at 2110 may include using socio-economic data, firmographic data, sales data, and so on to generate initial target segments and initial pricing models.

At 2120, the system may design and conduct surveys/interviews and analyze responses to understand stakeholder behavior leveraging BE models. The initial target segmentation and initial pricing models determined/developed at 2110 may be used to inform the survey and/or interview design and behavior analysis at 2120. The survey and/or interview design and behavior analysis at 2120 may also be informed by data from past studies and includes an analysis of the survey responses. The survey may be designed to elicit information regarding behavioral factors (e.g., beliefs, values, environmental factors, and so on) and/or may be designed to compare preferences between two or more choices based on a comparison of features and prices (e.g., a conjoint analysis). The survey and/or behavior analysis may also be used to identify or generate pricing and demand models (e.g., related to a demand curve and/or price elasticity) and/or possible business actions. Some elements related to survey and/or interview design and behavior analysis at 2120 are discussed above in relation to FIGS. 6-8 pertaining to B2C use case as an example.

At 2130, the system may select optimal business action types (and magnitude range) for each target stakeholder segment using ABMS and RL including initial pricing & demand models to guide RL rewards. Business action types selection for each target stakeholder at 2130 may be informed by the survey and/or interview design and behavior analysis at 2120, product features, and features of different stakeholder segments (e.g., identified during the stakeholder group segmentation at 2110). The business action types for each target stakeholder may be updated based on feedback from subsequent stages (e.g., business action types test and/or empirical evidence). The Business action types selection for target segments at 2130 may produce a set of best business action types and magnitude ranges of the business action types (e.g., amounts of discount). The best business action types may be a set of business action types that maximize a profit or other metric based on a current state of an interaction episode and a set of characteristics of a customer. The best business action types may be produced based on a RL module (or other machine learning component) and/or methodology.

In some aspects, at 2140, the system may deploy selected business action types to a small random sample of stakeholders from each target segment and gather empirical outcome of these action types. In some aspects, the test stakeholder profiles may include stakeholder interaction data. The empirical outcomes of the testing may be fed back to business action types selection for the optimal business action types selection, at 2130, e.g., to be used to train a reinforcement learning module and/or update a training of the reinforcement learning module (or other machine learning module, neural network, or other similar module).

At 2150, the system may train a personalized business action recommendation engine using individual stakeholder profiles (including past business transactions) and empirical outcome data of tested business action types produce a personalized business action model (e.g., as provided based on deploying selected business action types at 2140). The personalized business action types may identify a set of different business actions for different segments of a stakeholder base and situations in which each business action may be suggested (e.g., may represent a business action with a highest expected value among the set of different business actions). The set of business actions for each segment may be based the output of previous stages as well as on social media data, purchase data, or other demographic (or firmographic) data collected in any previous stage. Personalized business actions and associated expected values are explained above in reference to FIGS. 13-15.

At 2160, the system may recommend at least one personalized business action for at least one individual stakeholder using trained model and profile data associated with the at least one individual stakeholder. The personalized business action recommendation engine may access data regarding a particular stakeholder, e.g., data stored in a stakeholder profile, social media data, and/or purchase history data, and use the personalized business action model to generate a business action recommendation for a current stakeholder interaction that is part of an ongoing or new stakeholder interaction episode.

Finally, at 2170, the system may measure and evaluate an outcome of a business action for an individual stakeholder for feeding back to the personalized business action model. For example, the recommended business action may be implemented (e.g., a discount offer may be made, additional information may be provided, or a different recommended intervention may be carried out) and a response to the business action may be received and/or an outcome of the business action or of the interaction episode may be identified. For example, at a particular stage of an interaction episode additional information may be provided and no purchase made and, at a subsequent stage of the interaction episode a discount offer may be provided and a purchase made. Measuring and evaluating an outcome, at 2170, may include recording the response to each particular interaction as well as the ordered set of interactions along with the outcome of the interaction episode (e.g., a purchase). This may be used along with other data regarding other interaction episodes, for example, to identify that a discount offer is more likely than additional information to result in a purchase and/or that the discount offer works more effectively after additional information has been presented than before. For example, the data collected at 2170 may be fed back to train, at 2150, the personalized business action recommendation engine to update the personalized business action model. In some aspects, the personalized business action model may use a weighted business action to introduce some variability to allow data to be collected regarding different business actions or business action sequences for subsequent training,

FIG. 22 is a flow diagram of a method for providing business action recommendations. The method may be performed by a machine-learning-based recommendation engine or a system that includes a machine-learning-based recommendation engine (e.g., a system illustrated in FIGS. 2 and 12). At 2210, the system may collect data relating to behavioral characteristics of multiple stakeholders, the collected data comprising at least data required to analyze stakeholder behaviors using a behavioral economics model. The data collection may further include, (1) collecting, from a set of stakeholders, stakeholder survey data relating to a set of behavioral questions and/or collecting, from a set of stakeholders, stakeholder survey data relating to a set of conjoint analysis questions. The behavioral questions may relate to at least one of attitudes towards a product, perceived attitudes of other people towards the product, or an importance of different features of the product. The survey questions and conjoint analysis questions may be generated based on behavioral economics principles as discussed above in relation to FIGS. 1, 5, and 6.

Business action recommendations provided by the machine-learning-based recommendation engine may include at least one of an information campaign, a discount offer, a financing offer, or a warranty offer in a consumer product use case. Other business action may be used in different use cases or for different products. Additionally, stakeholder responses to recommended business actions may include at least one of no action, an inquiry about an intervention, or a purchase or other response as might be appropriate for a given use case. Applying to the B2C use case as an example, referring to FIGS. 6 and 7 above, the data collection may include receiving answers to survey questions as illustrated in FIG. 6 or may include coding interventions and responses as indicated in FIG. 7. In some aspects, the collected data further comprises at least one of demographic data, socio-economic data, firmographic data, sales data, or other customer profile data that is readily accessible. Collecting, at 2210, in some aspects, may include collecting data for modeling at least one of a demand curve for a product or a price elasticity for the product.

At 2220, the system may generate, based on the collected data, simulated customer interaction data related to the business problem. Applying to the B2C use case as an example, referring to FIGS. 11 and 12, a market simulator 1120 may receive input from a behavior model 1130 and a demographics generator 1140 and generate simulated customer interaction data. The demographics generator 1140 may generate simulated demographic data based on the collected data. In some aspects, the behavior model 1130 may be based on a behavioral economics model.

At 2230, the system may train, based on the simulated customer interaction data, a machine-learning-based recommendation engine. Applying to the B32C use case as an example, training the machine-learning-based recommendation engine, in some aspects, may include a training as discussed in relation to FIGS. 13 and 15. Training the machine-learning-based recommendation engine may also include generating a model of at least one of a demand curve for a product or a price elasticity for the product for identifying a business action (e.g., intervention) including a discount based on the modeled demand curve or price elasticity.

In some aspects, applying to the B2C use case as an example, the training may further include identifying customer segments using the machine-learning-based customer segmentation engine and training the machine-learning-based recommendation engine (e.g., a recommendation policy) further includes training the machine-learning-based recommendation engine based on the identified customer groups. The identified customer groups, sometimes called micro-segments, may be automatically discovered using machine learning and defined using customer characteristic data. Micro-segmentation may allow a user to identify customer characteristics that may be more useful for identifying a customer segment than standard (e.g., intuitive) customer segmentation based on age, gender, region, or other such characteristics used to segment a customer population. The training of the machine-learning-based recommendation engine, in some aspects, further includes training the machine-learning-based recommendation engine based on the identified customer groups (e.g., micro-segments).

Applying to the B2C use case as an example, the system may collect demographic data used to determine a customer segment (or micro-segment) associated with the particular customer and information relating to any previous business action presented to the particular customer. The data related to the interaction episode, in some aspects, defines a state used by a machine-learning-based recommendation engine to determine a recommended business action.

Finally, at 2240, applying to the B2C use case as an example, the system (or machine-learning-based recommendation engine) may provide a business action recommendation for a customer interaction, where the business action recommendation is provided by the trained machine-learning-based recommendation engine based on a state of the customer interaction. Applying the recommendation policy may include determining a current state value associated with the interaction episode. The recommendation policy comprises an association between a set of input customer interaction states and a set of recommended business actions, as described above in relation to FIG. 13. Specifically, each customer interaction state in the set of input customer interaction states may be associated with one recommended business action in the set of recommended business actions. For example, in some aspects, each of multiple states may be associated with a set of action values (e.g., state 1300 of FIG. 13 is associated with action values 1307-1307). Each action value in the set of action values may be (1) associated with a behavioral intervention (e.g., interventions 1301-1303) applied to a set of customers in the state of the plurality of states (e.g., state 1300). Each action value may represent a value (e.g., representing a profit or sales measurement) associated with the responses to the set of customers to the associated behavioral intervention. In some aspects, the behavioral intervention associated with a particular state is the behavioral intervention associated with an action value that is higher than action values associated with other behavioral interventions. For example, referring to FIG. 13, for a state 1300, a behavioral intervention 1301 is associated with a highest action-value 1307 and is the recommended behavioral intervention 1315 given a state 1300.

The determined current state value may be determined based on the interventions that have taken place in the current interaction episode as well as a customer segment associated with the particular customer such that even with the same intervention history, two different recommendations may be made for different customers in different customer segments. For example, in some aspects, the current state value may be determined based on at least one of a set of characteristics of the particular customer, a set of behavioral interventions already employed during the interaction episode, or a set of customer responses to the set of behavioral interventions already employed during the interaction episode. Other implementations may use different criteria for determining a state of a current interaction episode as dictated by the particular business optimization problem and behavioral model employed.

The recommendation policy may be generated offline in a batch mode and updated in real time. For example, after providing the recommendation, the system may implement the recommended behavioral intervention, collect data relating to a customer response to the implemented behavioral intervention, and update the recommendation policy based on the collected data relating to the customer response to the implemented behavioral intervention. Alternatively, after the interaction episode, the data of the interaction episode may be used to update the recommendation policy in real-time or in an offline mode.

More generally, the method described above may include providing personalized business decision recommendations by a personalized business action recommendation engine. For example, the method may collect behavioral characteristic data relating to a plurality of stakeholders and a plurality of business action types associated with a behavioral economics model related to the plurality of stakeholders and the plurality of business action types. The behavioral characteristics and business action types may be based on the specific implementation (business optimization problem to be solved). Training a reinforcement learning policy of the personalized business action recommendation engine using the collected stakeholder characteristic data is substantially similar to one or more of the use cases discussed above, while being tailored to the specific application.

The method may collect data related to an interaction episode with a particular stakeholder and provide a personalized business decision recommendation for a next business decision associated with the interaction episode based on applying the reinforcement learning policy to the collected data for the interaction episode. The collected data about the interaction episode may be used to identify a state that can be provided to the personalized business action recommendation engine to generate a personalized business decision recommendation as discussed above.

FIG. 23 illustrates an example computing environment with an example computer device suitable for use in some example implementations. Computer device 2305 in computing environment 2300 can include one or mom processing units, cores, or processors 2310, memory 2315 (e.g., RAM, ROM, and/or the like), internal storage 2320 (e.g., magnetic, optical, solid-state storage, and/or organic), and/or IO interface 2325, any of which can be coupled on a communication mechanism or bus 2330 for communicating information or embedded in the computer device 2305. IO interface 2325 is also configured to receive images from cameras or provide images to projectors or displays, depending on the desired implementation.

Computer device 2305 can be communicatively coupled to input/user interface 2335 and output device/interface 2340. Either one or both of the input/user interface 2335 and output device/interface 2340 can be a wired or wireless interface and can be detachable. Input/user interface 2335 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 2340 may include a display, television, monitor, printer, speaker, braille, or the like. In some example implementations, input/user interface 2335 and output device/interface 2340 can be embedded with or physically coupled to the computer device 2305. In other example implementations, other computer devices may function as or provide the functions of input/user interface 2335 and output device/interface 2340 for a computer device 2305.

Examples of computer device 2305 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 2305 can be communicatively coupled (e.g., via IO interface 2325) to external storage 2345 and network 2350 for communicating with any number of networked components, devices, and systems, including one or more computer devices of the same or different configuration. Computer device 2305 or any connected computer device can be functioning as, providing services of, or referred to as a server, client, thin server, general machine, special-purpose machine, or another label.

IO interface 2325 can include but is not limited to, wired and/or wireless interfaces using any communication or IO protocols or standards (e.g., Ethernet, 2302.11x, Universal System Bus, WiMax, modem, a cellular network protocol, and the like) for communicating information to and/or from at least all the connected components, devices, and network in computing environment 2300. Network 2350 can be any network or combination of networks (e.g., the Internet, local area network, wide area network, a telephonic network, a cellular network, satellite network, and the like).

Computer device 2305 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CI) ROM, digital video disks, Blu-ray disks), solid-state media (e.g., RAM, ROM, flash memory, solid-state storage), and other non-volatile storage or memory.

Computer device 2305 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 2310 can execute under any operating system (OS)(not shown), in a native or virtual environment. One or more applications can be deployed that include logic unit 2360, application programming interface (API) unit 2365, input unit 2370, output unit 2375, and inter-unit communication mechanism 2395 for the different units to communicate with each other, with the OS, and with other applications (not shown). The described units and elements can be varied in design, function, configuration, or implementation and are not limited to the descriptions provided. Processor(s) 2310 can be in the form of hardware processors such as central processing units (CPUs) or in a combination of hardware and software units.

In some example implementations, when information or an execution instruction is received by API unit 2365, it may be communicated to one or more other units (e.g., logic unit 2360, input unit 2370, output unit 2375). In some instances, logic unit 2360 may be configured to control the information flow among the units and direct the services provided by API unit 2365, the input unit 2370, the output unit 2375, in some example implementations described above. For example, the flow of one or more processes or implementations may be controlled by logic unit 2360 alone or in conjunction with API unit 2365. The input unit 2370 may be configured to obtain input for the calculations described in the example implementations, and the output unit 2375 may be configured to provide an output based on the calculations described in example implementations.

Processor(s) 2310 can be configured to collect data relating to characteristics of a plurality of stakeholders, the collected data comprising at least data associated with a behavioral economics model related to a business problem. The processor(s) 2310 may also be configured to generate, based on the collected data, simulated stakeholder interaction data related to the business problem. The processor(s) 2310 may further be configured to train, based on the simulated stakeholder interaction data, a machine-learning-based recommendation engine. The processor(s) 2310 may further be configured to provide a business action recommendation for a stakeholder interaction, where the business action recommendation is provided by the trained machine-learning-based recommendation engine based on a state of the stakeholder interaction. The processor(s) 2310 may also be configured to identify, using the machine-learning-based stakeholder segmentation engine, stakeholder segments. The processor(s) 2310 may also be configured to train the reinforcement learning policy by training the reinforcement learning policy based on the identified stakeholder groups. The processor(s) 2310 may also be configured to collect, from a set of stakeholders in the plurality of stakeholders, stakeholder survey data relating to a set of behavioral questions. The processor(s) 2310 may further be configured to collect, from a set of stakeholders in the plurality of stakeholders, stakeholder survey data relating to a set of conjoint analysis questions. The processor(s) 2310 may also be configured to model at least one of a demand curve for a product or a price elasticity for the product. The processor(s) 2310 may further be configured to implement the recommended business action. The processor(s) 2310 may also be configured to collect data relating to a stakeholder response to the implemented business action. The processor(s) 2310 may further be configured to update the reinforcement learning policy based on the collected data relating to the stakeholder response to the implemented business action. The processor(s) 2310 may further be configured to determine a current state value associated with the interaction episode, where the recommended business action is associated, by the reinforcement learning-policy, with the determined current state value associated with the interaction episode.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed:

1. A method of providing optimal and personalized business action recommendations, comprising:
collecting data relating to characteristics of a plurality of stakeholders, the collected data comprising at least data associated with a behavioral economics model related to a business problem;
generating, based on the collected data, simulated stakeholder interaction data related to the business problem;
training, based on the simulated stakeholder interaction data, a machine-learning-based recommendation engine; and
providing a business action recommendation for a stakeholder interaction, where the business action recommendation is provided by the trained machine-learning-based recommendation engine based on a state of the stakeholder interaction.

2. The method of claim 1, wherein:
the machine-leaning-based recommendation engine comprises a reinforcement-learning-based recommendation engine, the business action recommendation is a behavioral intervention recommendation,
training the reinforcement-learning-based recommendation engine comprises training a recommendation policy that associates an input stakeholder-interaction state with a behavioral interaction recommendation, and
training the reinforcement-learning-based recommendation engine comprises updating the recommendation policy based on additional stakeholder interaction data as it is received.

3. The method of claim 1, wherein the machine-learning-based recommendation engine comprises a statistical-regression-based recommendation engine for de-biasing projection data received from at least one stakeholder based on at least one of (1) a trust model or (2) a comparison of historical projection data received from the at least one stakeholder and received outcome data associated with the historical projection data.

4. The method of claim 1, wherein the machine-learning-based recommendation engine comprises a neural-network-based recommendation engine for identifying at least one of a set of stakeholder segments or a set of stakeholder micro-segments.

5. The method of claim 1, wherein the collected data further comprises at least one of demographic data, socio-economic data, firmographic data, sales data, or other stakeholder profile data that is readily accessible.

6. The method of claim 1, wherein the data associated with the behavioral economics model related to the business problem comprises at least one of behavioral-economics-informed survey response data or historical interaction data related to a particular behavioral economics model, wherein a behavioral-economics-informed survey used to generate the behavioral-economics-informed survey response data comprises at least one of a set of survey questions or a set of conjoint analysis questions, wherein the behavioral-economics-informed survey relates to at least one of attitudes towards a product, perceived attitudes of other people towards the product, an importance of different features of the product, or a value associated with one or more features of the product.

7. The method of claim 1, wherein the machine-learning-based recommendation engine further comprises a machine-learning-based stakeholder segmentation engine, the method further comprising:
identifying, using the machine-learning-based stakeholder segmentation engine, stakeholder segments; and
training the machine-learning-based recommendation engine further comprises training the machine-learning-based recommendation engine based on the identified stakeholder segments.

8. The method of claim 1, further comprising modeling at least one of a demand curve for a product or a price elasticity for the product.

9. The method of claim 1, wherein training the machine-learning-based recommendation engine comprises training the machine-learning-based recommendation engine to generate a recommendation policy, wherein the recommendation policy comprises an association between a set of input stakeholder interaction states and a set of recommended business actions, wherein each stakeholder interaction state in the set of input stakeholder interaction states is associated with one recommended business action in the set of recommended business actions, and wherein providing the business action recommendation for the stakeholder interaction based on the state of the stakeholder interaction comprises providing the recommended business action associated with the state of the stakeholder interaction.

10. The method of claim 9, the method further comprising:
implementing the business action recommendation:
collecting data relating to a stakeholder response to the business action recommendation; and
updating the recommendation policy based on the collected data relating to the stakeholder response to the implemented business action recommendation.

11. A computer-readable medium storing computer executable code for providing business action recommendations, the code when executed by a processor causes the processor to:
collect data relating to characteristics of a plurality of stakeholders, the collected data comprising at least data associated with a behavioral economics model related to a business problem;
generate, based on the collected data, simulated stakeholder interaction data related to the business problem;
train, based on the simulated stakeholder interaction data, a machine-learning-based recommendation engine; and
provide a business action recommendation for a stakeholder interaction, where the business action recommendation is provided by the trained machine-learning-based recommendation engine based on a state of the stakeholder interaction.

12. The computer-readable medium of claim 11, wherein the machine-learning-based recommendation engine comprises at least one of a reinforcement-learning-based recommendation engine, a statistical-regression-based recommendation engine, or a neural-network-based recommendation engine.

13. The computer-readable medium of claim 11, wherein the collected data further comprises at least one of demographic data, socio-economic data, firmographic data, sales data, or other stakeholder profile data that is readily accessible.

14. The computer-readable medium of claim 11, wherein the data associated with the behavioral economics model related to the business problem comprises at least one of behavioral-economics-informed survey response data or historical interaction data related to a particular behavioral economics model, wherein a behavioral-economics-informed survey used to generate the behavioral-economics-informed survey response data comprises at least one of a set of survey questions or a set of conjoint analysis questions, wherein the behavioral-economics-informed survey relates to at least one of attitudes towards a product, perceived attitudes of other people towards the product, an importance of different features of the product, or a value associated with one or more features of the product.

15. The computer-readable medium of claim 11, wherein the machine-learning-based recommendation engine further comprises a machine-learning-based stakeholder segmentation engine, the code when executed by the processor further causes the processor to:
identify, using the machine-learning-based stakeholder segmentation engine, stakeholder segments; and
train the machine-learning-based recommendation engine by training the machine-learning-based recommendation engine based on the identified stakeholder segments.

16. The computer-readable medium of claim 11, further comprising modeling at least one of a demand curve for a product or a price elasticity for the product.

17. The computer-readable medium of claim 11, wherein training the machine-learning-based recommendation engine comprises training the machine-learning-based recommendation engine to generate a recommendation policy, wherein the recommendation policy comprises an association between a set of input stakeholder interaction states and a set of recommended business actions, wherein each stakeholder interaction state in the set of input stakeholder interaction states is associated with one recommended business action in the set of recommended business actions, and wherein providing the business action recommendation for the stakeholder interaction based on the state of the stakeholder interaction comprises providing the recommended business action associated with the state of the stakeholder interaction.

18. The computer-readable medium of claim 17, the code when executed by the processor further causes the processor to:
implement the business action recommendation;
collect data relating to a stakeholder response to the business action recommendation; and
update the recommendation policy based on the collected data relating to the stakeholder response to the implemented business action recommendation.

19. A system comprising:
at least one processor; and
a computer-readable medium storing computer executable code for providing business action recommendations code, the code when executed by the at least one processor causes the at least one processor to:
collect data relating to characteristics of a plurality of stakeholders, the collected data comprising at least data associated with a behavioral economics model related to a business problem;
generate, based on the collected data, simulated stakeholder interaction data related to the business problem;
train, based on the simulated stakeholder interaction data, a machine-learning-based recommendation engine; and
provide a business action recommendation for a stakeholder interaction, where the business action recommendation is provided by the trained machine-learning-based recommendation engine based on a state of the stakeholder interaction.

20. The system of claim 19, the code when executed by the processor further causes the processor to:
implement the business action recommendation;
collect data relating to a stakeholder response to the business action recommendation; and
update the machine-learning-based recommendation engine based on the collected data relating to the stakeholder response to the implemented business action recommendation.
